(19) United States
(12) Patent Application Publication
(10) Pub. No.: US 2026/0280985 A1
(43) Pub. Date: Sep. 17, 2026

(54) Generating Models Of Data Center Fabrics

(71) Applicant: Oracle International Corporation, Redwood Shores, CA (US)

(72) Inventors: Erik Sabiun, Vilnius (LT); Thomas Patrick Booth, Redmond, WA (US); Andrew B. Dickinson, Seattle, WA (US); Charles S. Gordon, Mountain View, CA (US); Manasa Pola, Bothell, WA (US); Helali Bhuiyan, Sammamish, WA (US); Robert Lee Tesch, II, Seattle, WA (US)

(73) Assignee: Oracle International Corporation, Redwood Shores, CA (US)

(21) Appl. No.: 19/229,837

(22) Filed: Jun. 5, 2025

Related U.S. Application Data
(60) Provisional application No. 63/771,223, filed on Mar. 13, 2025.

(51) Int. Cl. H04L 41/0894; H04L 49/25

(52) U.S. Cl. CPC H04L 41/0894; H04L 49/25

(57) ABSTRACT

A system instantiates a fabric model entity that includes a data structure representing a model of a fabric. The fabric model entity includes a first group entity representing a first set of device model entities corresponding to a first portion of the model and a second group entity representing a second set of device model entities corresponding to a second portion of the model. The system selects a linking rule that defines one or more criteria for linking the first set of device model entities of the first group entity to the second set of device model entities of the second group entity. Based on the linking rule, the system instantiates, in the model, a linking entity that defines a set of links between the first set of device model entities of the first group entity and the second set of device model entities of the second group entity.

### INCORPORATION BY REFERENCE; DISCLAIMER

This application claims the benefit of U.S. Provisional Patent Application No. 63/771,223, filed Mar. 13, 2025, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to generating models that represent network fabrics of data centers.

### BACKGROUND

A network fabric of a data center includes a set of interconnected switches and links that provide multiple redundant pathways for data flow between a set of computing devices. Network traffic is routed dynamically across the fabric, leveraging the redundant paths to balance load and maintain connectivity. A model of a data center fabric defines an architectural structure, operational framework, and/or data flow of one or more network fabrics of a data center. The model of the data center fabric can be utilized in connection with designing, building, and/or operating a data center.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment and refer to at least one embodiment. In the drawings:

FIG. 1 is a block diagram that depicts features of an example system for executing operations pertaining to generating a model of a data center fabric in accordance with one or more embodiments;

FIGS. 2A and 2B are block diagrams that depict features of an example model of a data center fabric in accordance with one or more embodiments;

FIGS. 3A and 3B are flowcharts that depict example operations pertaining to generating a model of a data center fabric in accordance with one or more embodiments;

FIG. 4 is a block diagram that depicts an example model of a data center fabric in accordance with one or more embodiments;

FIGS. 5-8 are block diagrams illustrating patterns for implementing a cloud infrastructure as a service system in accordance with one or more embodiments;

FIG. 9 is a high-level diagram of a distributed environment showing a virtual or overlay cloud network hosted by a cloud service provider infrastructure according to certain embodiments;

FIG. 10 depicts a simplified architectural diagram of the physical components in the physical network within cloud infrastructure (CI) according to certain embodiments;

FIG. 11 depicts a simplified block diagram of a physical network provided by a CI, according to certain embodiments;

FIG. 12 depicts a data center containing rows of compute racks and network racks, with the network racks implementing a network fabric, according to certain embodiments; and

FIG. 13 illustrates a block diagram that depicts features of an example a hardware system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The term “cloud computing service” or “cloud service” is generally used to refer to a service that is made available by a cloud services provider (CSP) to users or customers on demand (e.g., via a subscription model) using systems and infrastructure (cloud infrastructure) provided by the CSP.

In most cases, the CSP is a third-party service that specializes in providing (e.g., offering, renting, selling) cloud services to customers. The servers and systems that make up the CSP's infrastructure are separate from the customer's own on-premises servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services. In some instances, an entity might opt to deploy a private cloud, becoming its own provider of cloud services. In some instances, an entity may utilize both a private cloud and a public cloud provided by a third-party CSP, thereby forming a hybrid cloud.

There are several cloud service providers that offer various types of cloud services. There are various different types or models of cloud services including Software-as-a-Service (SaaS), Platform-as-a-Service (PaaS), Infrastructure-as-a-Service (IaaS), and others. In an IaaS model, the CSP provides infrastructure (referred to as “cloud services provider infrastructure” or “CSPI”) that can be used by customers to build their own customizable networks and deploy customer resources.

A customer can subscribe to one or more cloud services provided by a CSP. The customer can be any entity, and the like. When a customer subscribes to or registers for a service provided by a CSP, a tenancy, or an account, is created for that customer. The customer can then, via this account, access the subscribed-to one or more cloud resources associated with the account.
1. GENERAL OVERVIEW
2. DEFINITIONS
3. EXAMPLE DATA CENTER FABRIC MODELING ARCHITECTURE
4. EXAMPLE DATA CENTER FABRIC MODELS
5. EXAMPLE DATA CENTER FABRIC MODELING OPERATIONS
6. EXAMPLE EMBODIMENT OF A DATA CENTER FABRIC MODEL
7. EXAMPLES OF CLOUD INFRASTRUCTURE
8. EXAMPLES OF CLOUD NETWORKS
9. EXAMPLE NETWORK FABRICS
10. HARDWARE SYSTEM
11. MISCELLANEOUS; EXTENSIONS

### 1. General Overview

One or more embodiments generate links between groups of equipment model entities in a model of a data center fabric based on linking rules. In one example a system instantiates a fabric model entity in a model of a data center fabric based on a fabric model template selected from a catalog. The fabric model entity includes a data structure representing at least a portion of the model of the data center fabric. The fabric model entity includes multiple group entities, such as one or more fabric group entities and/or one or more client group entities. In one example, the fabric model entity includes a first group entity representing a first set of equipment model entities corresponding to a first portion of the model of the data center fabric and a second group entity representing a second set of equipment model entities corresponding to a second portion of the model of the data center fabric. The system selects linking rules that define criteria for linking the equipment model entities, of the respective group entities, with one another. The system may select different linking rules for linking different sets of equipment model entities of different sets of group entities. The equipment model entities may include device model entities, rack model entities, and/or port model entities. In one example, system selects a first linking rule that defines one or more criteria for linking the first set of device model entities of the first group entity to the second set of device model entities of the second group entity. Based on the selected linking rules, the system instantiates linking entities, in the model of the data center fabric, that define the sets of links between the device model entities of the respective group entities. In one example, based on the first linking rule, the system instantiates a first linking entity that defines a set of links between the first set of device model entities of the first group entity and the second set of device model entities of the second group entity. The linking entities may define logical links and/or physical links between device model entities.

One or more embodiments described in this Specification and/or recited in the claims may not be included in this General Overview section.

### 2. Definitions

As used herein, the term “fabric model template” refers to a data structure that is utilized to generate a fabric model entity that represents a fabric model. The data structure of the fabric model template includes a set of fields that specify information that can be included to generate a fabric model entity from the fabric model template. At least one field, of the set of fields, includes a data element that represents an attribute of a fabric model entity that can be generated from the fabric model template. Different fabric model entities can be generated from a particular fabric model template. In one example, a fabric model entity may be configurable for a set of fabric model entities that share at least one attribute in common. Additionally, or alternatively, different fabric model templates may be utilized to generate different fabric model entities, such as fabric model entities that differ from one another with respect to one or more attributes. In one example, a fabric model template may be prepopulated with one or more device model templates and/or with one or more rack model templates.

As used herein, the term “fabric model entity” refers to an instance of a data structure generated based on a fabric model template to represent a particular fabric model. Generating a fabric model entity may include associating the fabric model entity with a model of a data center fabric. A fabric model entity that is associated with a model of a data center fabric is considered part of the model of the data center fabric. A fabric model entity may conform to the data structure defined by the particular fabric model template. The data structure of the fabric model entity includes a set of fields with data elements that specify attributes of the fabric model represented by the fabric model entity. The attributes included in the set of fields of the fabric model entity can vary in content depending on the fabric model represented by the fabric model entity. One or more data elements can be added to one or more fields, of the set of fields, when generating a fabric model entity from a fabric model template. Additionally, or alternatively, one or more fields of the fabric model entity can be prepopulated with a data element from the fabric model template. A prepopulated field of a fabric model template can be retained or overwritten when generating a fabric model entity from the fabric model template. In one example, a fabric model entity includes one or more device model entities and/or one or more rack model entities. The one or more device model entities may be generated based on one or more device model templates that are prepopulated in the fabric model template utilized to generate the fabric model entity. Additionally, or alternatively, one or more device model entities may be associated with the fabric model entity when generating the fabric model entity and/or when generating the one or more device model entities. The one or more rack model entities may be generated based on one or more rack model templates that are prepopulated in the fabric model template utilized to generate the fabric model entity. Additionally, or alternatively, one or more rack model entities may be associated with the fabric model entity when generating the fabric model entity and/or when generating the one or more rack model entities.

As used herein, the term “fabric model” refers to a conceptual representation of particular design or configuration of a fabric. A fabric model can be represented by a fabric model entity. The particular design or configuration of the fabric can be described by the attributes included in the data structure of the fabric model entity. The attributes that describe the particular design or configuration of the fabric may include fabric type information (e.g., whether the fabric is a backend fabric, a frontend fabric, or a management fabric). Additionally, or alternatively, the attributes that describe the particular design or configuration of the fabric may include fabric topology information, such as the types, size, and/or number of tiers included in the fabric.

In one example, a fabric model template include a set of group templates. A group template includes a data structure that represents a portion of the fabric model template. A group template is utilized to generate a group entity that represents a portion of a fabric model entity. A group entity may represent at least a portion of a particular tier of the fabric model entity. The group templates may include fabric group templates and/or client group templates. A fabric group template is utilized to generate a fabric group entity of a fabric model entity. A fabric group entity represents a portion of the fabric that includes switch devices. A client group template is utilized to generate a client group entity of a fabric model entity. A client group entity represents a set of client devices that are connected to the fabric and/or that represent a portion of the fabric. The client devices may include compute devices (e.g., servers, graphics processing units, tensor processing units, or field-programmable gate arrays) or storage device (e.g., hard disk drives or solid-state drives).

As used herein, the term “equipment model template” refers to a data structure that is utilized to generate an equipment model entity that represents an equipment model. An equipment model template may include one or more of: a rack model template, a device model template, or a port model template.

As used herein, the term “equipment model entity” refers to an instance of a data structure generated based on an equipment model template to represent a particular equipment model. Generating an equipment model entity may include associating the equipment model entity with a model of a data center fabric. In one example, generating an equipment model entity includes associating the equipment model entity with a fabric model entity and/or a group entity in a model of a data center fabric. An equipment model entity that is associated with a model of data center fabric is considered part of the model of the data center fabric. Additionally, or alternatively, an equipment model entity that is associated with a fabric model entity may be considered part of the fabric model entity. An equipment model entity may conform to the data structure defined by the particular equipment model template. The data structure of the equipment model entity includes a set of fields with data elements that specify attributes of the equipment model represented by the equipment model entity. The attributes included in the set of fields of the equipment model entity can vary in content depending on the equipment model represented by the equipment model entity. One or more data elements can be added to one or more fields, of the set of fields, when generating an equipment model entity from an equipment model template. Additionally, or alternatively, one or more fields of the equipment model entity can be prepopulated with a data element from the equipment model template. A prepopulated field of an equipment model template can be retained or overwritten when generating an equipment model entity from the equipment model template. An equipment model entity may include one or more of: a rack model entity, a device model entity, or a port model entity. A rack model entity, a device model entity, and/or a port model entity may be generated based on one or more templates that are prepopulated in the equipment model template utilized to generate the equipment model entity. Additionally, or alternatively, A rack model entity, a device model entity, and/or a port model entity may be associated with the equipment model entity when generating the equipment model entity.

As used herein, the term “equipment model” refers to a conceptual representation of particular design or configuration of one or more items of equipment. The one or more items of equipment may include equipment utilized in a data center. An equipment model can be represented by an equipment model entity. The particular design or configuration of the equipment can be described by the attributes included in the data structure of the equipment model entity. An equipment model may include one or more of: a rack model, a device model, or a port model.

As used herein, the term “rack model template” refers to a data structure that is utilized to generate a rack model entity that represents a rack model. The data structure of the rack model template includes a set of fields that specify information that can be included to generate a rack model entity from the rack model template. At least one field, of the set of fields, includes a data element that represents an attribute of a rack model entity that can be generated from the rack model template. Different rack model entities can be generated from a particular rack model template. In one example, a rack model entity may be configurable for a set of rack model entities that share at least one attribute in common. Additionally, or alternatively, different rack model templates may be utilized to generate different rack model entities, such as rack model entities that differ from one another with respect to one or more attributes. In one example, a rack model template may be prepopulated with one or more device model templates.

As used herein, the term “rack model entity” refers to an instance of a data structure generated based on a rack model template to represent a particular rack model. Generating a rack model entity may include associating the rack model entity with a model of a data center fabric. In one example, generating a rack model entity includes associating the rack model entity with a fabric model entity and/or a group entity in a model of a data center fabric. A rack model entity that is associated with a model of data center fabric is considered part of the model of the data center fabric. Additionally, or alternatively, a rack model entity that is associated with a fabric model entity may be considered part of the fabric model entity. A rack model entity may conform to the data structure defined by the particular rack model template. The data structure of the rack model entity includes a set of fields with data elements that specify attributes of the rack model represented by the rack model entity. The attributes included in the set of fields of the rack model entity can vary in content depending on the rack model represented by the rack model entity. One or more data elements can be added to one or more fields, of the set of fields, when generating a rack model entity from a rack model template. Additionally, or alternatively, one or more fields of the rack model entity can be prepopulated with a data element from the rack model template. A prepopulated field of a rack model template can be retained or overwritten when generating a rack model entity from the rack model template. In one example, a rack model entity includes one or more device model entities. The one or more device model entities may be generated based on one or more device model templates that are prepopulated in the rack model template utilized to generate the rack model entity. Additionally, or alternatively, one or more device model entities may be associated with the rack model entity when generating the rack model entity and/or when generating the one or more device model entities.

As used herein, the term “rack model” refers to a conceptual representation of particular design or configuration of a rack. A rack model can be represented by a rack model entity. The particular design or configuration of the rack can be described by the attributes included in the data structure of the rack model entity. The attributes that describe the particular design or configuration of the rack may include one or more of the following: identifying information, rack type information, physical aspects, or location compatibility information. Identifying information may include one or more of the following: rack identifier (e.g., a unique identifier, such as a rack name, serial number, or asset tag), model identifier (e.g., make or model number of the rack), or vendor identifier (e.g., information identifying the vendor that supplies the rack). Rack type information may indicate whether the rack is an open frame rack, an enclosed rack, or a lockable rack. Additionally, or alternatively, rack type information may indicate whether the rack is designed for switch devices, compute devices, or storage devices. Physical aspects may include information pertaining to rack capacity (e.g., number of rack units, rack height), power requirements (e.g., voltage, current, redundancy specifications), cooling requirements (e.g., coolant type, coolant flow rating, coolant flow direction). Location compatibility information may identify locations within a data center where the rack is compatible for use, such as compatible rows, pods, sites, rooms, or data halls.

As used herein, the term “device model template” refers to a data structure that is utilized to generate a device model entity that represents a device model. The data structure of the device model template includes a set of fields that specify information that can be included to generate a device model entity from the device model template. At least one field, of the set of fields, includes a data element that represents an attribute of a device model entity that can be generated from the device model template. Different device model entities can be generated from a particular device model template. In one example, a device model entity may be configurable for a set of device model entities that share at least one attribute in common. Additionally, or alternatively, different device model templates may be utilized to generate different device model entities, such as device model entities that differ from one another with respect to one or more attributes.

As used herein, the term “device model entity” refers to an instance of a data structure generated based on a device model template to represent a particular device model. Generating a device model entity may include associating the device model entity with a model of a data center fabric. In one example, generating a device model entity includes associating the device model entity with at least one of a fabric model entity, a group entity, or a rack model entity, in a model of a data center fabric. A device model entity that is associated with a model of a data center fabric is considered part of the model of the data center fabric. Additionally, or alternatively, a device model entity that is associated with a group entity may be considered part of the group entity. Additionally, or alternatively, a device model entity that is associated with a rack model entity may be considered part of the rack model entity. A device model entity may conform to the data structure defined by the particular device model template. The data structure of the device model entity includes a set of fields with data elements that specify attributes of the device model represented by the device model entity. The attributes included in the set of fields of the device model entity can vary in content depending on the device model represented by the device model entity. One or more data elements can be added to one or more fields, of the set of fields, when generating a device model entity from a device model template. Additionally, or alternatively, one or more fields of the device model entity can be prepopulated with a data element from the device model template. A prepopulated field of a device model template can be retained or overwritten when generating a device model entity from the device model template.

As used herein, the term “device model” refers to a conceptual representation of particular design or configuration of a device. A device model can be represented by a device model entity. The particular design or configuration of the device can be described by the attributes included in the data structure of the device model entity. The attributes that describe the particular design or configuration of the device may include one or more of the following: identifying information, device type information, configuration information, physical aspects, connectivity aspects, role compatibility information, or location compatibility information. Identifying information may include one or more of the following: device identifier (e.g., a unique identifier, such as a host name, serial number, or asset tag), model identifier (e.g., make or model number of the device), or vendor identifier (e.g., information identifying the vendor that supplies the device). Device type information may indicate whether the device is a switch device, a compute device, or a storage device. Additionally, or alternatively, device type information may indicate a type of switch device (e.g., form factor, number of rack units, modularity), a type of compute device (e.g., server, graphics processing unit, tensor processing unit, or field-programmable gate array), or a type of storage device (e.g., hard disk drive or solid-state drive). Configuration information may include information pertaining to an operating system, firmware, or software installed on the device and/or that is compatible with the device. Physical aspects may include information pertaining to rack unit compatibility (e.g., rack units occupied by the device, compatible rack types), power requirements (e.g., voltage, current, redundancy specifications), cooling requirements (e.g., coolant type, coolant flow rating, coolant flow direction). Connectivity aspects may include switch information (e.g., port types, number of ports (port density) for upstream and/or downstream ports), interface types (e.g., ethernet or fiber interface), speed information (e.g., per-port speed, switching capacity, forwarding rate, latency parameters), or redundancy configurations. Role compatibility information may identify compatible roles for the device, such as whether the device is compatible for use as a leaf switch and/or as a spine switch. Additionally, or alternatively, role compatibility information may identify compatible fabric types, architectures, and/or topologies. Location compatibility information may identify locations within a data center where the device is compatible for use, such as compatible racks, rack positions, rows, pods, sites, rooms, or data halls.

As used herein, the term “port model template” refers to a data structure that is utilized to generate a port model entity that represents a port model. The data structure of the port model template includes a set of fields that specify information that can be included to generate a port model entity from the port model template. At least one field, of the set of fields, includes a data element that represents an attribute of a port model entity that can be generated from the port model template. Different port model entities can be generated from a particular port model template. In one example, a port model entity may be configurable for a set of port model entities that share at least one attribute in common. Additionally, or alternatively, different port model templates may be utilized to generate different port model entities, such as port model entities that differ from one another with respect to one or more attributes.

As used herein, the term “port model entity” refers to an instance of a data structure generated based on a port model template to represent a particular port model. Generating a port model entity may include associating the port model entity with a model of a data center fabric. In one example, generating a port model entity includes associating the port model entity with at least one of a fabric model entity, a group entity, a rack model entity, or a device model entity, in a model of a data center fabric. A port model entity that is associated with a model of a data center fabric is considered part of the model of the data center fabric. Additionally, or alternatively, a port model entity that is associated with a group entity may be considered part of the group entity. Additionally, or alternatively, a port model entity that is associated with a rack model entity may be considered part of the rack model entity. Additionally, or alternatively, a port model entity that is associated with a device model entity may be considered part of the device model entity. A port model entity may conform to the data structure defined by the particular port model template. The data structure of the port model entity includes a set of fields with data elements that specify attributes of the port model represented by the port model entity. The attributes included in the set of fields of the port model entity can vary in content depending on the port model represented by the port model entity. One or more data elements can be added to one or more fields, of the set of fields, when generating a port model entity from a port model template. Additionally, or alternatively, one or more fields of the port model entity can be prepopulated with a data element from the port model template. A prepopulated field of a port model template can be retained or overwritten when generating a port model entity from the port model template.

As used herein, the term “port model” refers to a conceptual representation of particular design or configuration of a set of one or more ports of a device. A port model can be represented by a port model entity. The particular design or configuration of the set of one or more ports can be described by the attributes included in the data structure of the port model entity. The attributes that describe the particular design or configuration of the set of one or more ports may include one or more of the following: identifying information, port type information, or connectivity aspects. Identifying information may include one or more of the following: device identifier corresponding to the set of one or more ports (e.g., a unique identifier, such as a host name, serial number, or asset tag), model identifier of the device corresponding to the set of one or more ports (e.g., make or model number of the device), or vendor identifier corresponding to the set of one or more ports (e.g., information identifying the vendor that supplies the device). Device type information may indicate whether the device corresponding to the set of one or more ports is a switch device, a compute device, or a storage device. Connectivity aspects may include switch information (e.g., port types, number of ports (port density) for upstream and/or downstream ports), interface types (e.g., ethernet or fiber interface), speed information (e.g., per-port speed, switching capacity, forwarding rate, latency parameters), or redundancy configurations.

### 3. Example Data Center Fabric Modeling Architecture

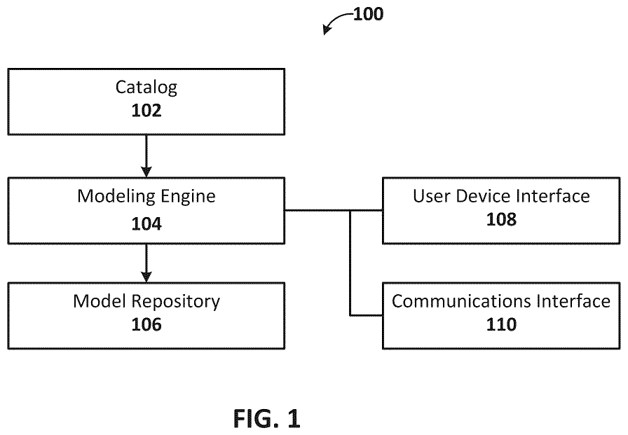

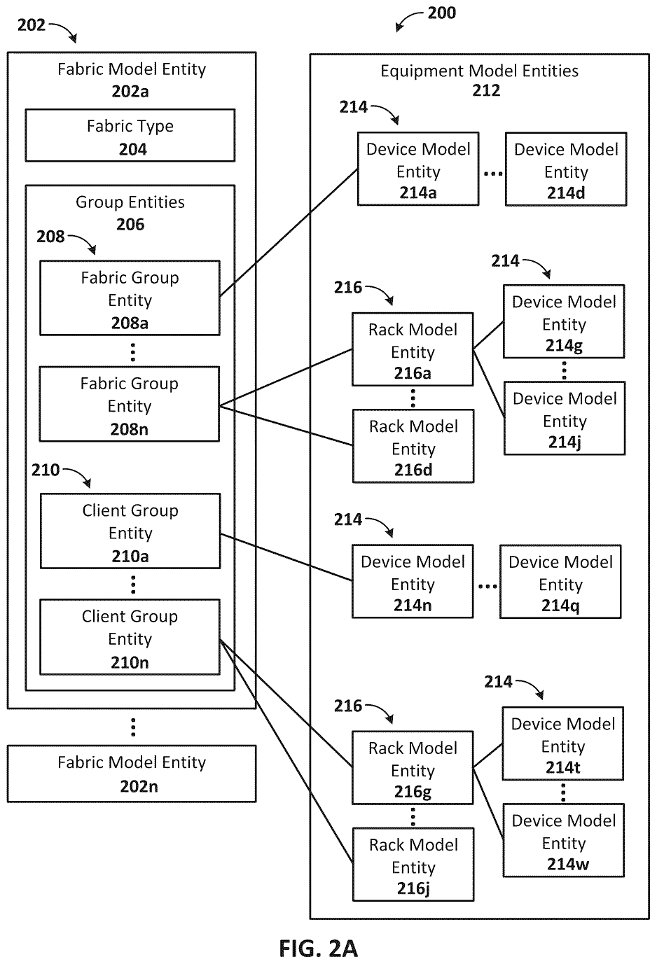

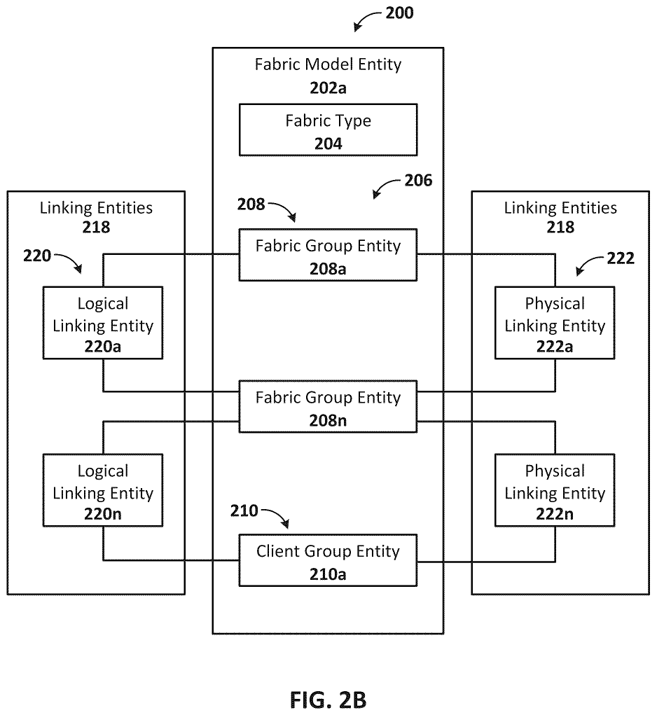

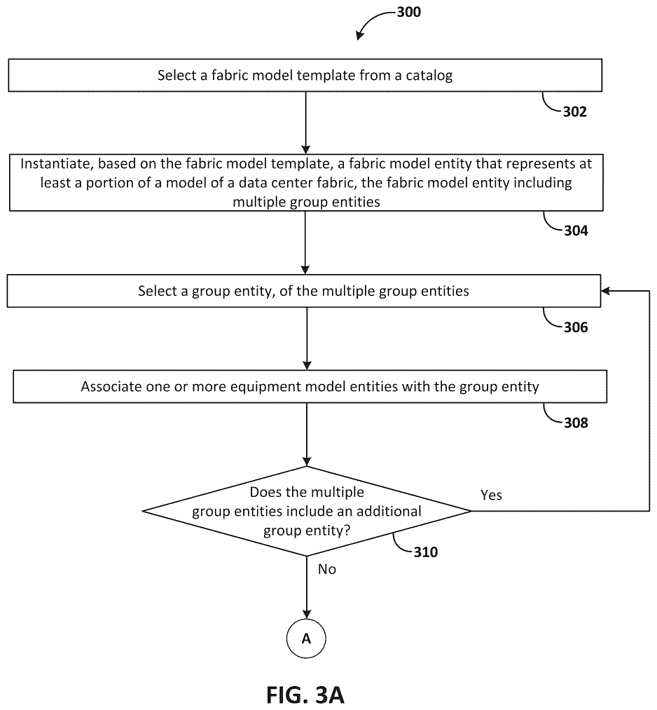

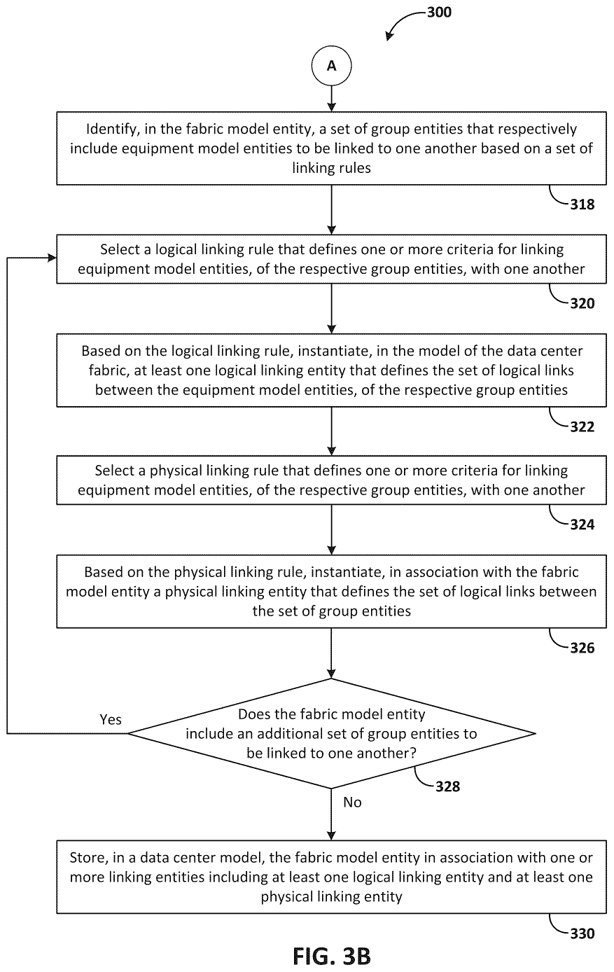

FIG. 1 illustrates features of an example system 100 for executing operations pertaining to generating a model of a data center fabric. In one or more embodiments, the system 100 refers to hardware and/or software configured to perform operations described herein. The operations include generating a model of a data center fabric. Example models of a data center fabric are described below with reference to FIGS. 2A and 2B. Examples of operations, including operations pertaining to generating a model of a data center fabric, are described below with reference to FIGS. 3A and 3B. In one or more embodiments, the system 100 may include more or fewer components than the components described with reference to FIG. 1. The components described with reference to FIG. 1 may be local to or remote from each other. The components described with reference to FIG. 1 may be implemented in software and/or hardware. The components of system 100 may be distributed over multiple applications and/or machines. Multiple components may be combined into one application and/or machine. Operations described with respect to one component may instead be performed by another component.

In one example, the system 100 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

As shown in FIG. 1, the system 100 includes a catalog 102, a modeling engine 104, and a model repository 106. The catalog 102 includes one or more data repositories that store templates for generating models of data center fabrics. The catalog 102 includes multiple templates that the modeling engine 104 can utilize to generate at least a portion of a model of a data center fabric. The templates may include fabric model templates, rack model templates, and device model templates. The modeling engine 104 generates models of data center fabrics and/or various portions of a model of a data center fabric based on one or more templates from the catalog 102. The modeling engine 104 may store the model of the data center fabric and/or the various components of the model in the model repository 106. The model repository 106 includes one or more data repositories for storing models of data center fabrics and/or various components of models of data center fabrics generated by the modeling engine 104.

In one or more embodiments, a data repository is any type of storage unit and/or device (e.g., a file system, database, collection of tables, or any other storage mechanism) for storing data. Furthermore, a data repository may include multiple different storage units and/or devices. The multiple different storage units and/or devices may or may not be of the same type or located at the same physical site. Furthermore, a data repository may be implemented or executed on the same computing system as the modeling engine 104. Additionally, or alternatively, a data repository may be implemented or executed on a computing system separate from the modeling engine 104. A data repository may be communicatively coupled to the modeling engine 104 via a direct connection or via a network. Information describing a data repository may be implemented across any of components of the system 100. However, the foregoing information is described with reference to the one or more data repositories for purposes of clarity and explanation.

Referring further to FIG. 1, the system 100 may include a user device interface 108 communicatively coupled or couplable with one or more other components of the system 100. A user device interface 108 may include hardware and/or software configured to facilitate interactions between a user and various aspects of the system 100. The user device interface 108 may render user interface elements and receive input via user interface elements. For example, the user device interface 108 may display outputs generated by the system 100. Additionally, or alternatively, the user device interface 108 may be configured to provide inputs to the system 100. Examples of interfaces include a graphical user interface (GUI), a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by a user device interface 108.

In an embodiment, different components of a user device interface 108 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, a user device interface 108 may be specified in one or more other languages, such as Java, C, or C++.

Additionally, or alternatively, the system 100 may include one or more communications interfaces 110 communicatively coupled or couplable with one or more components of the system 100. The one or more communications interfaces 110 may include hardware and/or software configured to transmit data between respective components of the system 100 and/or to transmit data to and/or from the system 100. For example, a communications interface 110 may transmit and/or receive data between and/or among one or more components of the system 100.

### 4. Example Data Center Fabric Models

Referring to FIGS. 2A and 2B, example models of data center fabrics 200 are further described. A model of a data center fabric 200 may be generated by the system described with reference to FIG. 1. The system may generate a model of a data center fabric 200 by executing one or more operations desired below with reference to FIGS. 3A and 3B.

As shown in FIG. 2A, a model of a data center fabric 200 includes one or more fabric model entities 202, such as fabric model entity 202a and fabric model entity 202n. As shown with respect to fabric model entity 202a, a fabric model entity 202 includes a fabric type 204. A model of a data center fabric 200 may include multiple fabric model entities 202 corresponding, respectively, to different fabric types 204. Example fabric types 204 include: a frontend fabric, a backend fabric, and a management fabric. As further shown with respect to fabric model entity 202a, a fabric model entity 202 includes a set of group entities 206. The set of group entities 206 may include one or more fabric group entities 208, such as fabric group entity 208a and fabric group entity 208n. Additionally, or alternatively, the set of group entities 206 may include one or more client group entities 210, such as client group entity 210a and client group entity 210n. A group entity 206 may include one or more equipment model entities 212, such as one or more device model entities 214 and/or one or more rack model entities 216. In one example, device model entities 214 may be directly associated with group entities 206, for example, without including any rack model entities 216. Additionally, or alternatively, rack model entities 216 may be associated with group entities 206, and device model entities 214 may be associated with rack model entities 216.

In one example, as shown in FIG. 2A, fabric group entity 208a includes device model entity 214a and device model entity 214d. Fabric group entity 208n includes rack model entity 216a and rack model entity 216d. A rack model entity 216 may include one or more device model entities 214. For example, as shown in FIG. 2A, rack model entity 216a includes device model entity 214g and device model entity 214j. As further shown, client group entity 210a includes device model entity 214n and device model entity 214q. Client group entity 210n includes rack model entity 216g and rack model entity 216j. Rack model entity 216g includes device model entity 214t and device model entity 214w. In one example, the system includes additional model entities besides those described in FIG. 2A. The additional model entities may include port model entities that represent ports and/or port group entities that represent groups of ports. Additionally, or alternatively, the additional model entities may include passive infrastructure model entities that represent passive infrastructure and/or passive group entities that represent groups of passive infrastructure. Example passive infrastructure includes cables, fiber, patch panels, fiber distribution panels, and/or cross-connects.

A group entity 206 may include a set of group entity parameters. The group entity parameters for a group entity 206 may define type of the group entity 206. The type of the group entity 206 may indicate whether the group entity 206 is a fabric group entity 208 or a client group entity 210. The group entity parameters for a fabric group entity 208 may indicate a role of the fabric group entity 208, such as whether the fabric group entity 208 is a leaf group or a spine group. Additionally, or alternatively, the group entity parameters for a fabric group entity 208 may indicate a role of allowed equipment model entities 212, such as a role of allowed device model entities 214 and/or a role of allowed rack model entities 216. The group parameters for a fabric group entity 208 may indicate whether the fabric group entity 208 allows leaf equipment models (e.g., leaf device models and/or leaf rack models) or spine equipment models (e.g., spine device models and/or spine rack models). The group entity parameters for a client group entity 210 may indicate a role of the client group entity 210, such as whether the client group entity 210 is a compute device or a storage device. Additionally, or alternatively, the group entity parameters for a client group entity 210 may indicate a role of allowed equipment model entities 212, such as a role of allowed device model entities 214 and/or a role of allowed rack model entities 216. The group parameters for a fabric group entity 208 may indicate whether the client group entity 210 allows compute equipment models (e.g., compute device models and/or compute rack models) or storage equipment models (e.g., storage device models and/or storage rack models). Additionally, or alternatively, the group entity parameters for a group entity 206 may indicate what equipment model entities 212 are allowed to be associated with the group entity 206, such as what device model entities 214 and/or rack model entities 216 are allowed to be associated with the group entity 206. Additionally, or alternatively, the group entity parameters for a group entity 206 may specify one or more values pertaining to a number of equipment model entities 212, such as a number of device model entities 214 and/or a number of rack model entities 216, that can be associated with and/or that are currently associated with the group entity 206. The one or more values may include a maximum and/or a minimum number of equipment model entities 212, such as a maximum and/or a minimum number of device model entities 214 and/or rack model entities 216, that can be associated with the group entity 206. Additionally, or alternatively, the one or more values may include a number of equipment model entities 212, such as a number of device model entities 214 and/or rack model entities 216, that are currently associated with the group entity 206.

As shown in FIG. 2B, a model of a data center fabric 200 includes one or more linking entities 218. The linking entities 218 define a set of links between the device model entities of different group entities 206. The links defined by the linking entities 218 are based on one or more linking rules for linking sets of group entities 206 with one another. The set of links may represent individual links between device model entities that conform to the linking rules.

In one example, a linking entity 218 defines, based on one or more linking rules for linking fabric group entities 208 to one another, a set of links between the equipment model entities 212 of different fabric group entities 208. In one example, a linking entity 218 defines a set of links, generated based on the one or more linking rules, that link one or more equipment model entities 212 of a first fabric group entity 208 with one or more equipment model entities 212 of a second fabric group entity 208. Additionally, or alternatively, a linking entity 218 may define a set of links, generated based on the one or more linking rules, that link one or more equipment model entities 212 of a fabric group entity 208 with one or more equipment model entities 212 of a client group entity 210. The linking entities 218 may include logical linking entities 220 and/or physical linking entities 222. A logical linking entity defines logical links, generated based on one or more logical linking rules, between equipment model entities 212 of different group entities 206. A physical linking entity 222 defines physical links, generated based on one or more physical linking rules, between equipment model entities 212 of different group entities 206.

### A. Example Logical Linking Rules

In one example, fabric group entity 208a and fabric group entity 208n may be linked to one another by logical linking entity 220a. Logical linking entity 220a includes one or more logical linking rules for linking fabric group entity 208a and fabric group entity 208n to one another. Additionally, or alternatively, fabric group entity 208n and client group entity 210a may be linked to one another by logical linking entity 220n. Logical linking entity 220a includes one or more logical linking rules for linking fabric group entity 208a and fabric group entity 208n to one another.

In one example, a logical linking rule of a logical linking entity 220 that links a first group entity 206 to a second group entity 206 indicates how one or more device model entities of the first group entity 206 are logically connected to one or more device model entities of the second group entity 206. A logical linking rule may include information that indicates whether particular device model entities of different group entities are linked to one another. Additionally, or alternatively, a logical linking rule may include information that indicates whether particular ports of different device model entities are linked to one another. In one example, a logical linking rule defines a linking arrangement corresponding to a fabric topology. The fabric topology may include one or more of the following: a Clos topology, a fat tree topology, a leaf-spine topology, a breakout topology, a mesh topology (e.g., full mesh or partial mesh), a torus topology, a hypercube topology, a ring topology, or a star topology.

In one example, a logical linking rule of a logical linking entity 220 that links a first group entity 206 to a second group entity 206 indicates that every device model entity of the first group entity 206 is connected to every device model entity of the second group entity 206. The logical linking rule indicating that every device model entity of the first group entity 206 is connected to every device model entity of the second group entity 206 may correspond to a Clos topology.

In one example, a logical linking rule of a logical linking entity 220 that links a first group entity 206 to a second group entity 206 indicates that every device model entity of the first group entity 206 is connected to multiple device model entities of the second group entity 206. The first group entity 206 may represent a lower tier of a fabric topology and the second group entity may represent a higher tier of a fabric topology. The connection to multiple device model entities may provide increased bandwidth at the higher tier of the fabric topology. The logical linking rule indicating that every device model entity of the first group entity 206 is connected to multiple device model entities of the second group entity 206 may correspond to a fat tree topology.

In one example, a logical linking rule of a logical linking entity 220 that links a first group entity 206 to a second group entity 206 indicates that multiple device model entities of the first group entity 206 are connected to a particular device model entity of the second group entity 206. The multiple device model entities of the first group entity 206 may be leaf switches, and the particular device model entity of the second group entity 206 may be a spine switch. The logical linking rule indicating that multiple device model entities of the first group entity 206 are connected to the particular device model entity of the second group entity 206 may correspond to a leaf-spine topology.

In one example, a logical linking rule of a logical linking entity 220 that links a first group entity 206 to a second group entity 206 indicates that every device model entity of the first group entity 206 has n-number of connections to every device model entity of the second group entity 206, where “n” is greater than (1). In one example, “n” is (2), such that every device model entity of the first group entity 206 has (2) connections to every device model entity of the second group entity 206. In one example, “n” is (4), such that every device model entity of the first group entity 206 has (4) connections to every device model entity of the second group entity 206. The logical linking rule indicating that every device model entity of the first group entity 206 has n-number of connections to every device model entity of the second group entity 206 may correspond to a breakout topology.

The following shows an example logical linking rule for connecting a first fabric group entity 208 that represents a leaf group to a second fabric group entity 208 that represents a spine group:
POST/logical_linkRules
{
   “fabricTypeld”:“fabric.BeeFab.Id”,
   “name”:“leaf-to-spine”,
   “from”:{
      “group”:“beLeaf”,
      “portGroup”:“uplink”,
   },
   “to”:{
      “group”:“beSpine”,
      “portGroup”:“downlink”
   },
   “mode”: “clos”
}
   In one example, logical linking entity 220a includes the preceding logical linking rule for linking fabric group entity 208n and fabric group entity 208a with one another, where fabric group entity 208n is a leaf group and fabric group entity 208a is a spine group.

The following shows an example logical linking rule for connecting a client group entity 210 to a fabric group entity 208:
POST/logical_linkRules
{
   “fabricTypeld”:“fabric.BeeFab.Id”,
   “name”:“gpu-to-leaf”,
   “from”:{
      “group”:“beGPU”,
      “slot”:“1”
      “ports”:“any”
   },
   “to”:{
      “group”:“beLeaf”,
   “groupNumber”:“equals”
   “portGroup”:“downlink”,
   “fabricNumber”: “1”
   },
   “mode”: “shuffle”
}
   In one example, logical linking entity 220n includes the preceding logical linking rule for linking client group entity 210a and fabric group entity 208n with one another.

### B. Example Physical Linking Rules

In one example, fabric group entity 208a and fabric group entity 208n may be linked to one another by physical linking entity 222a. Physical linking entity 222a includes one or more physical linking rules for linking fabric group entity 208a and fabric group entity 208n to one another. Additionally, or alternatively, fabric group entity 208n and client group entity 210a may be linked to one another by physical linking entity 222n. Physical linking entity 222a includes one or more physical linking rules for linking fabric group entity 208n and client group entity 210a to one another. A physical linking rule of a physical linking entity 222 that links a first group entity 206 to a second group entity 206 indicates how one or more device model entities of the first group entity 206 are physically connected to one or more device model entities of the second group entity 206.

In one example, a physical linking rule may include information that indicates a type of cabling utilized for connections between device model entities. The physical linking rule may indicate that the cabling includes copper cabling, such as ethernet cable or direct attach copper cable. Additionally, or alternatively, the physical linking rule may indicate that the cabling includes fiber optic cable, such as multi-mode fiber or single-mode fiber. In one example, the physical linking rule may indicate a type of transceiver and/or a connector type for connecting cabling to a device model entity. The type of transceiver may include a quad small form-factor pluggable transceiver, such as a QSFP28 (100G) transceiver or a QSFP-DD (400G) transceiver. The type of connector may include a multi-fiber push-on/pull-off connector, an LC connector, or an SN connector. Additionally, or alternatively, a physical linking rule may include information that indicates whether device model entities are connected via direct connections or structured cabling.

In one example, a physical linking rule may include information that indicates whether passive infrastructure is utilized for connecting device model entities. When passive infrastructure is utilized, the physical linking rule may indicate the types of passive infrastructure. The passive infrastructure may include patch panels, fiber distribution panels, and/or cross-connects. In one example, a physical linking rule of a physical linking entity 222 that links a first group entity 206 to a second group entity 206 indicates that device model entities of the first group entity 206 are connected to one or more passive infrastructure components, and that the one or more passive infrastructure components are connected to device model entities of the second group entity 206.

The following shows an example physical linking rule for connecting a first fabric group entity 208 that represents a leaf group to a second fabric group entity 208 that represents a spine group:
POST/physical_linkRules
{
   “fabricTypeld”:“fabric.BeeFab.Id”,
   “name”: “leaf-to-spine”,
   “from”:{
      “group”:“beLeaf”,
      “portGroup”:“uplink”,
   },
   “to”:{
      “group”:“passivegear”,
      “portGroup”:“downlink”
      “passivegearattributes”: “patchpanel”
   },
   “from”:{
      “group”:“passivegear”,
      “portGroup”:“uplink”,
   },
   “to”:{
      “group”:“beSpine”,
      “portGroup”:“downlink”
   },
      “mode”: “clos”
      “wire”: {cable: qsfp-sfp-dac-breakout}
}
   In one example, physical linking entity 2228a includes the preceding physical linking rule for linking fabric group entity 208n and fabric group entity 208a with one another, where fabric group entity 208n is a leaf group and fabric group entity 208a is a spine group.

### 5. Example Data Center Fabric Modeling Operations

Referring to FIGS. 3A and 3B, operations pertaining to generating a model of a data center fabric are further described. One or more operations described with reference to FIGS. 3A and 3B may be modified, rearranged, or omitted. Accordingly, the particular sequence of operations described with reference to FIGS. 3A and 3B should not be construed as limiting the scope of one or more embodiments. In one example, the operations described with reference to FIGS. 3A and 3B may be performed by one or more features of the system described with reference to FIG. 1. Additionally, or alternatively, the operations described with reference to FIGS. 3A and 3B may be executed to generate models of data center fabrics that include one or more features described with reference to FIGS. 2A and 2B.

To generate a model of the data center fabric, a system instantiates one or more fabric model entities that include a data structure that represents a model of at least a portion of the data center fabric. The fabric model entity may include multiple group entities and/or the system may associate multiple group entities with the fabric model entity. As described with reference to FIG. 3A, the system may associate multiple equipment model entities with the multiple group entities of a fabric model entity. As described with reference to FIG. 3B, the system may instantiate, in the model of the data center fabric, one or more linking entities that define a set of links between equipment model entities of different group entities.

A. Associating Equipment Model Entities with Group Entities

Referring to FIG. 3A, operations 300 pertaining to associating equipment model entities with group entities are further described. As described with reference to FIG. 3A, the operations 300 include associating a set of one or more equipment model entities with group entities of a fabric model entity. The one or more equipment model entities may include one or more device model entities and/or one or more rack model entities. Additionally, or alternatively, the one or more equipment model entities may include port model entities. The system associates a fabric type with the model of the data center fabric and adds a fabric model entity corresponding to the fabric type to the model of the data center fabric. In one example, the system associates a first group entity and a second group entity with a fabric model entity. The first group entity represents at least a first set of equipment model entities, such as a first set of device model entities, corresponding to a first portion of the model of the data center fabric. The second group entity represents at least a second set of equipment model entities, such as a second set of device model entities. corresponding to a second portion of the model of the data center fabric.

As shown in FIG. 3A, a system selects a fabric model template from a catalog (Operation 302). The system may select the fabric model template based on an input from a user device interface. After selecting the fabric model template from the catalog, the system instantiates a fabric model entity based on the fabric model template (Operation 304). The fabric model entity represents at least a portion of a model of a data center fabric. The fabric model entity may include multiple group entities. The multiple group entities may include one or more fabric group entities and/or one or more client group entities. The system instantiates the fabric model entity by adding the fabric model entity to the model of the data center fabric.

After instantiating the fabric model entity, the system adds one or more rack model entities and/or one or more device model entities to the group entities. The system may add rack model entities and/or device model entities to a group entity based on one or more inputs from a user device interface. Additionally, or alternatively, the system may add rack model entities and/or device model entities to a group entity based on parameters of the group entity that indicates rack model entities and/or device model entities to be added. Additionally, or alternatively, the system may present a set of rack model entities and/or device model entities for selection. The system may receive a selection via an input from a user device interface. The system may add the selected rack model entities and/or device model entities to the group entity.

As shown in FIG. 3A, the system selects a group entity, of the multiple group entities (Operation 306). After selecting a group entity, the system associates one or more equipment model entities with the group entity (Operation 308). The system may associate an equipment model entity with the group entity by adding the equipment model entity to the group entity, and/or by defining a link between the equipment model entity and the group entity. In one example, the system associates one or more device model entities with the group entity. The system may associate a device model entity with the group entity by adding the device model entity to the group entity, and/or by defining a link between the device model entity and the group entity. Additionally, or alternatively, the system may associate one or more rack model entities with the group entity. When the system associates a rack model entity with the group entity, the system may additionally associate one or more device model entities with the rack model entity. The system may associate a rack model entity with the group entity by adding the rack model entity to the group entity, and/or by defining a link between the rack model entity and the group entity. The system may associate a device model entity with the rack model entity by adding the device model entity to the rack model entity, and/or by defining a link between the device model entity and the rack model entity. After associating the one or more equipment model entities with the group entity, the system determines whether the multiple group entities includes an additional group entity (Operation 310). When the system determines that the multiple group entities includes an additional group entity, the system selects the additional group entity, and associates one or more equipment model entities with the additional group entity.

### B. Applying Linking Rules For Linking Sets Of Group Entities With One Another

Referring to FIG. 3B, operations 300 pertaining to selecting linking rules and instantiating linking entities based on the linking rules are further described. The linking rules define one or more criteria for linking equipment model entities of different group entities with one another. The linking entities define sets of links between the equipment model entities of the different group entities based on the linking rules. As described with reference to FIG. 3B, the operations 300 include selecting logical linking rules for defining logical links between sets of group entities and instantiating logical linking entities based on the logical linking rules. Additionally, or alternatively, the operations 300 may include selecting physical linking rules for defining physical links between sets of group entities and instantiating physical linking entities based on the physical linking rules.

As shown in FIG. 3B, the system identifies, in the fabric model entity, a set of group entities that respectively include equipment model entities to be linked to one another based on a set of linking rules (Operation 318). The equipment model entities may include device model entities, rack model entities, and/or port model entities. The system may determine that a set of equipment model entities of a group entity are to be linked to a set of equipment model entities of one or more other group entities based on one or more parameters of the group entity. Additionally, or alternatively, the system may determine that a set of equipment model entities of a group entity is to be linked to a set of equipment model entities of one or more other group entities based on an input from a user interface device. In one example, the system determines that a set of equipment model entities of a first fabric group entity are to be linked to a set of equipment model entities of a second fabric group entity. The first fabric group entity may be a leaf group entity and the second fabric group entity may be a spine group entity. Additionally, or alternatively, the system may determine that a set of equipment model entities of a client group entity are to be linked to a set of equipment model entities of a fabric group entity.

After identifying a set of group entities that respectively include equipment model entities to be linked to one another, the system selects a logical linking rule that defines one or more criteria for linking equipment model entities, of the respective group entities, with one another (Operation 320). In one example, the logical linking rule indicates whether a first set of equipment model entities of a first group entity are to be linked to a second set of equipment model entities of a second group entity. In one example, the logical linking rule includes a parameter that indicates whether the first set of equipment model entities of the first group entity are to be logically linked to the second set of equipment model entities of the second group entity. The logical linking rule may indicate whether device model entities are linked to one another and/or whether port model entities are linked to one another.

In one example, the logical linking rule includes a linking arrangement corresponding to at least one tier of a fabric topology. In one example, the linking arrangement indicates that every equipment model entity of a first set of equipment model entities is linked to every equipment model entity of a second set of equipment model entities. Additionally, or alternatively, the logical linking arrangement may indicate that equipment device model entity of the first set of equipment model entities is linked to multiple equipment model entities of the second set of equipment model entities. Additionally, or alternatively, the logical linking arrangement may indicate that multiple equipment model entities of the first set of equipment model entities are linked to a particular equipment model entity of the second set of equipment model entities. Additionally, or alternatively, the logical linking arrangement may indicate that every equipment model entity of the first set of device model entities has n-number of links to every equipment model entity of the second set of equipment model entities.

The system may select the logical linking rule based on one or more parameters of a group entity, of the set of group entities. Additionally, or alternatively, the system may select the logical linking rule based on one or more parameters of at least one equipment model entity associated with the group entity. In one example, the system selects the logical linking rule based on a linking mode and/or a role indicated by the one or more parameters. Additionally, or alternatively, the system may select the logical linking rule based on an input from a user device interface. Additionally, or alternatively, the system may present a set of logical linking rules for selection. The system may receive a selection via an input from a user device interface.

Based on the logical linking rule, the system instantiates, in the model of the data center fabric, at least one logical linking entity that defines a set of logical links between the equipment model entities, of the respective group entities (Operation 322). The system instantiates the logical linking entity by adding the logical linking entity to the model of a data center fabric. In one example, the system adds the logical linking entity to the fabric model entity. In one example, the system adds the logical linking rule to the logical linking entity. In one example, the system generates a set of logical links between the set of group entities. In one example, the system iteratively generates a set of logical links for one or more device model entities of the set of group entities. In one example, for a logical linking rule that calls for a logical link between every device model entity of a first group entity and every device model entity of a second group entity, the system may iteratively select a set of device model entities and generate a logical link between them. The system may iteratively generate logical links, for example, until the logical lining entity includes a logical link between every device model entity of the first group entity and every device model entity of the second group entity. Upon generating the logical links, the logical linking entity defines the set of logical links between the set of group entities specified by the logical linking rule.

After instantiating the logical linking entity, the system selects a physical linking rule that defines one or more criteria for linking equipment model entities, of the respective group entities, with one another (Operation 324). In one example, the physical linking rule indicates whether a first set of equipment model entities of a first group entity are to be linked to a second set of equipment model entities of a second group entity. In one example, the physical linking rule includes a parameter that indicates whether the first set of equipment model entities of the first group entity are to be physically linked to the second set of equipment model entities of the second group entity. The physical linking rule may indicate whether device model entities are linked to one another and/or whether port model entities are linked to one another.

In one example, a physical linking rule includes a parameter that indicates a type of cabling utilized for a set of connections between the first set of equipment model entities and the second set of equipment model entities. Additionally, or alternatively, the physical linking rule may include a parameter that indicates whether the first set of device model entities are linked to the second set of device model entities via direct connections. Additionally, or alternatively, the physical linking rule may include a parameter that indicates whether the first set of device model entities are linked to the second set of device model entities via structured cabling. Additionally, or alternatively, the physical linking rule may include a parameter that indicates a type of transceiver for connections between the first set of device model entities and the second set of device model entities. Additionally, or alternatively, the physical linking rule may include one or more parameters that indicate one or more types of connectors, respectively, for connections between the first set of device model entities and the second set of device model entities. Additionally, or alternatively, the physical linking rule may include one or more parameters that indicate whether passive infrastructure is utilized for connections between the first set of device model entities and the second set of device model entities.

In one example, the physical linking rule includes a linking arrangement corresponding to at least one tier of a fabric topology. In one example, the linking arrangement indicates that every equipment model entity of a first set of equipment model entities is linked to every equipment model entity of a second set of equipment model entities. Additionally, or alternatively, the physical linking arrangement may indicate that equipment device model entity of the first set of equipment model entities is linked to multiple equipment model entities of the second set of equipment model entities. Additionally, or alternatively, the physical linking arrangement may indicate that multiple equipment model entities of the first set of equipment model entities are linked to a particular equipment model entity of the second set of equipment model entities. Additionally, or alternatively, the physical linking arrangement may indicate that every equipment model entity of the first set of device model entities has n-number of links to every equipment model entity of the second set of equipment model entities.

The system may select the physical linking rule based on one or more parameters of a group entity, of the set of group entities. Additionally, or alternatively, the system may select the physical linking rule based on one or more parameters of at least one equipment model entity associated with the group entity. Additionally, or alternatively, the system may select the physical linking rule based on one or more parameters of a logical linking entity that links the set of group entities to one another. In one example, the system selects the physical linking rule based on a linking mode and/or a role indicated by the one or more parameters. Additionally, or alternatively, the system may select the physical linking rule based on an input from a user device interface. Additionally, or alternatively, the system may present a set of physical linking rules for selection. The system may receive a selection via an input from a user device interface.

Based on the physical linking rule, the system instantiates, in the model of the data center fabric, at least one physical linking entity that defines a set of physical links between the equipment model entities, of the respective group entities (Operation 326). The system instantiates the physical linking entity by adding the physical linking entity to the model of the data center fabric. In one example, the system adds the physical linking entity to the fabric model entity. In one example, the system adds the physical linking rule to the physical linking entity. In one example, the system generates a set of physical links between the set of group entities. In one example, the system iteratively generates a set of physical links for one or more device model entities of the set of group entities. In one example, for a physical linking rule that calls for a physical link between every device model entity of a first group entity and every device model entity of a second group entity, the system may iteratively select a set of device model entities and generate a physical link between them. The system may iteratively generate physical links, for example, until the physical lining entity includes a physical link between every device model entity of the first group entity and every device model entity of the second group entity. Upon generating the physical links, the physical linking entity defines the set of physical links between the set of group entities specified by the physical linking rule.

After instantiating the physical linking entity, the system determines whether the fabric model entity include an additional set of group entities to be linked to one another (Operation 328). When the system determines that the fabric model entity includes an additional set of group entities to be linked to one another, the system instantiates an additional logical linking entity that defines an additional set of logical links between the additional set of group entities. Additionally, or alternatively, the system may instantiate an additional physical linking entity that defines an additional set of physical links between the additional set of group entities. After the system has instantiated the logical linking entities and the physical linking entities corresponding to the fabric model entity, the system stores the fabric model entity in the model of the data center fabric (Operation 330). The system may store the model of the data center fabric, including the fabric model entity in a data repository. The system may store the fabric model entity in association with one or more linking entities. The one or more linking entities may include at least one logical linking entity and at least one physical linking entity.

### 6. Example Embodiment of a Data Center Fabric Model

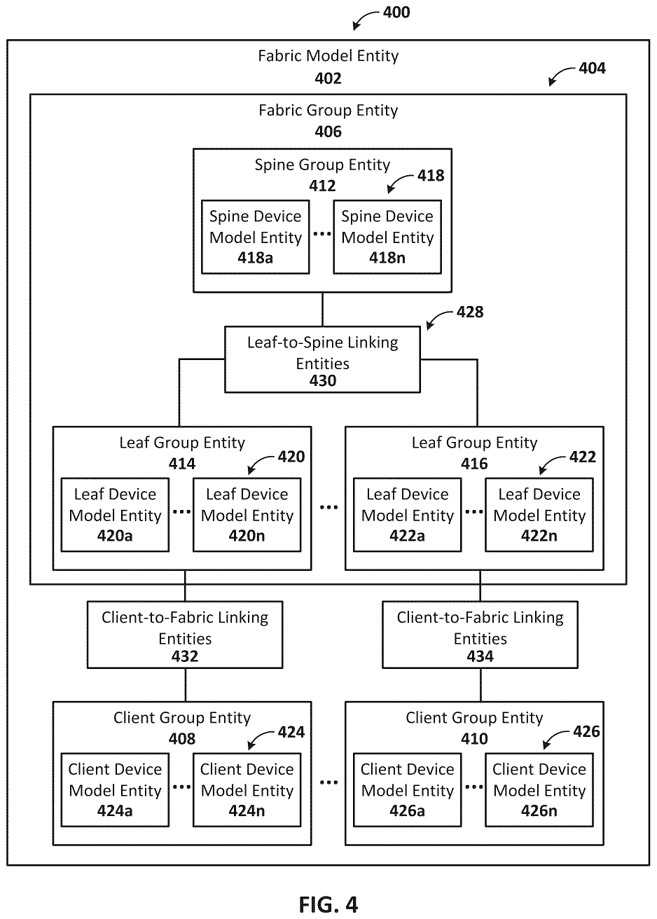

FIG. 4 shows an example embodiment of a model of a data center fabric 400. The model of the data center fabric 400 includes a fabric model entity 402. The fabric model entity 402 includes a data structure that represents at least a portion of the model of the data center fabric 400. The fabric model entity 402 includes a set of group entities 404. In one example, the set of group entities 404 include fabric group entity 406, client group entity 408, and client group entity 410. The fabric group entity 406 represents a portion of the data center fabric that is modeled by the fabric model entity 402. In one example, the data center fabric represented by the fabric group entity 406 is a back-end fabric. Additionally, or alternatively, the fabric group entity 406 may represent a front-end fabric and/or a management fabric. Client group entity 408 and client group entity 410, respectively, represent a set of client devices that are connected to the data center fabric that is modeled by the fabric model entity 402. Additionally, or alternatively, client group entity 408 and client group entity 410, respectively, represent the portion of the data center fabric that is modeled by the fabric model entity 402.

As shown in FIG. 4, the fabric group entity 406 includes multiple sub-entities. The sub-entities of the fabric group entity 406 are also fabric group entities that represent a portion of the data center fabric that is modeled by the fabric model entity 402. The sub-entities of the fabric group entity 406 include spine group entity 412, leaf group entity 414 and leaf group entity 416. Spine group entity 412 represents a spine portion of the data center fabric that is modeled by the fabric model entity 402. Leaf group entity 414 and leaf group entity 416, respectively, represent leaf portions of the data center fabric that is modeled by the fabric model entity 402. Spine group entity 412 includes a set of spine device model entities 418, such as spine device model entity 418a and spine device model entity 418n. The spine device model entities 418 represent particular device models that are included in the spine portion of the data center fabric that is modeled by spine group entity 412. Leaf group entity 414 includes a set of leaf device model entities 420, such as leaf device model entity 420a and leaf device model entity 420n. The leaf device model entities 420 represent particular device models that are included in the leaf portion of the data center fabric that is modeled by leaf group entity 414. Leaf group entity 416 includes a set of leaf device model entities 422, such as leaf device model entity 422a and leaf device model entity 422n. The leaf device model entities 422 represent particular device models that are included in the leaf portion of the data center fabric that is modeled by leaf group entity 416. Client group entity 408 includes a set of client device model entities 424, such as client device model entity 424a and client device model entity 424n. The client device model entities 424 represent particular device models that are connected to the data center fabric and/or that represent a portion of the data center fabric modeled by the fabric model entity 402. Client group entity 410 includes a set of client device model entities 426, such as client device model entity 426a and client device model entity 426n. The client device model entities 426 represent particular device models that are connected to the data center fabric and/or that represent a portion of the data center fabric modeled by the fabric model entity 402.

The fabric model entity 402 includes a set of linking entities 428 that define links between sets of device model entities corresponding to different portions of the data center fabric modeled by the fabric model entity 402. As shown in FIG. 4, the set of linking entities 428 includes one or more leaf-to-spine linking entities 430 that define a set of links between the spine device model entities 418 of spine group entity 412 and at least one of: the set of leaf device model entities 420 of leaf group entity 414 or the set of leaf device model entities 422 of leaf group entity 416. In one example, a leaf-to-spine linking entity 430 defines a set of links between a set of leaf device model entities 420 of a leaf group entity 414 and a set of spine device model entities 418 of a spine group entity 412. The set of links defined by the leaf-to-spine linking entity 430 may include, for each leaf device model entity 420 of the leaf group entity 414, at least one link with at least one spine device model entity 418 of the spine group entity 412. In one example, each spine device model entity 418, of the spine group entity 412, may be linked with at least one leaf device model entity 420, of the leaf group entity 414, by at least one link of the set of links. Additionally, or alternatively, a subset of spine device model entities 418, of the spine group entity 412, may be linked with a leaf device model entity 420, of the leaf group entity 414.

Additionally, as shown in FIG. 4, the set of linking entities 428 includes one or more client-to-fabric linking entities 432 and one or more client-to-fabric linking entities 434. The one or more client-to-fabric linking entities 432 define a set of links between the leaf device model entities 420 of leaf group entity 414 and the set of client device model entities 424 of client group entity 408. In one example, a client-to-fabric linking entity 432 defines a set of links between a set of client device model entities 424 of a client group entity 408 and a set of leaf device model entities 420 of a leaf group entity 414. The set of links defined by the client-to-fabric linking entity 432 may include, for each client device model entity 424 of the client group entity 408, at least one link with at least one leaf device model entity 420 of the leaf group entity 414. In one example, each leaf device model entity 420, of the leaf group entity 414, may be linked with at least one client device model entity 424, of the client group entity 408, by at least one link of the set of links. Additionally, or alternatively, a subset of leaf device model entities 420, of the leaf group entity 414, may be linked with a client device model entity 424 of the client group entity 408. The one or more client-to-fabric linking entities 434 define a set of links between the leaf device model entities 422 of leaf group entity 416 and the set of client device model entities 426 of client group entity 410. In one example, the client device model entities 426 of client group entity 410 are not linked to the set of leaf device model entities 420 of leaf group entity 414. Additionally, or alternatively, in one example, the client-to-fabric linking entities 432 do not define links between the client device model entities 426 of client group entity 410 and the leaf device model entities 420 of leaf group entity 414.

### 7. Examples of Cloud Infrastructure

As noted above, infrastructure as a service (IaaS) is one particular type of cloud computing. For IaaS, the infrastructure (CSPI) provided by a CSP can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
cid1.<RESOURCE TYPE>.<REALM>.[REGION][.FUTURE USE].<UNIQUE ID>
where,
cid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

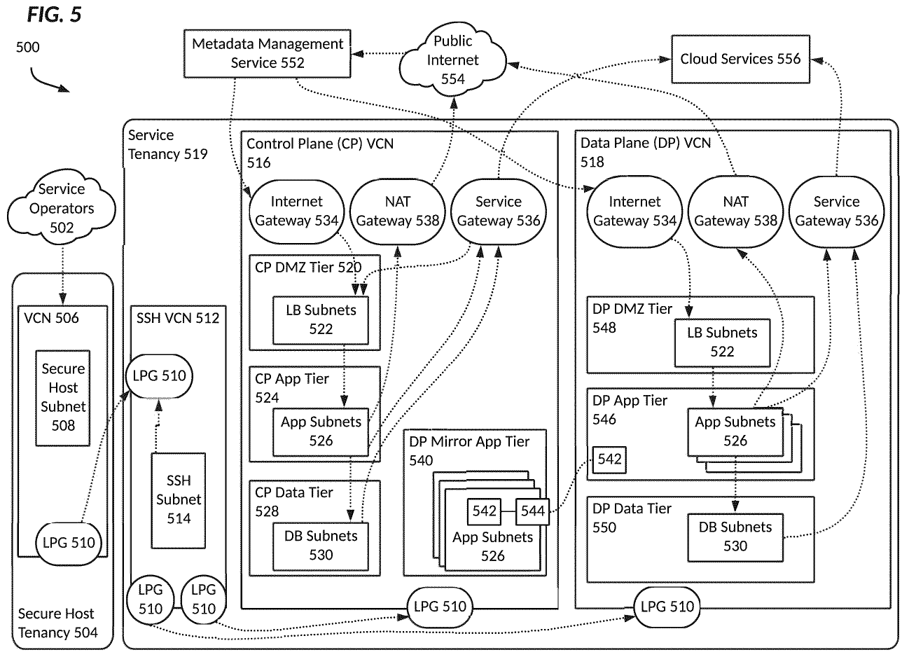

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, that may be portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, by way of example, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 implemented in the SSH VCN 512. The SSH VCN 512 can include an SSH subnet 514, and the SSH VCN 512 can be communicatively coupled to a control plane VCN 516 via the LPG 510 implemented in the control plane VCN 516. Also, the SSH VCN 512 can be communicatively coupled to a data plane VCN 518 via an LPG 510. The control plane VCN 516 and the data plane VCN 518 can be implemented in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 in the control plane DMZ tier 520 can be communicatively coupled to the app subnet(s) 526 in the control plane app tier 524 and an Internet gateway 534 that can be implemented in the control plane VCN 516. The app subnet(s) 526 can be communicatively coupled to the DB subnet(s) 530 implemented in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 implemented in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be implemented in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way; the service gateway 536 can make API calls to cloud services 556, and cloud services 556 can send requested data to the service gateway 536. However, cloud services 556 may not initiate API calls to the service gateway 536.

In some examples, the secure host tenancy 504 can be directly connected to the service tenancy 519. The service tenancy 519 may otherwise be isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision resources. Resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be implemented in the data plane mirror app tier 540 and the data plane app tier 546.

In some examples, users or customers, of the system, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 implemented in the control plane DMZ tier 520. The LB subnet(s) 522 may determine that the request is valid, and in response, the LB subnet(s) 522 can transmit the request to app subnet(s) 526 implemented in the control plane app tier 524. If the request is validated and requires a call to public Internet 554, the call to public Internet 554 may be transmitted to the NAT gateway 538 that can make the call to public Internet 554. Metadata to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to a configuration may need to be applied to the resources implemented in the data plane VCN 518. Via a VNIC 542, the control plane VCN 516 can directly communicate with, and can thereby execute the changes, updates, or other suitable modifications to configuration to, resources implemented in the data plane VCN 518.

In some embodiments, the control plane VCN 516 and the data plane VCN 518 can be implemented in the service tenancy 519. In this case, the user, or the customer, of the system may not own or operate either the control plane VCN 516 or the data plane VCN 518. Instead, the IaaS provider may own or operate the control plane VCN 516 and the data plane VCN 518. The control plane VCN 516 and the data plane VCN 518 may be implemented in the service tenancy 519. This embodiment can enable isolation of networks that may prevent users or customers from interacting with other users', or other customers', resources. Also, this embodiment may allow users, or customers, of the system to store databases privately without needing to rely on public Internet 554, that may not have a sufficient level of threat protection, for storage.

In other embodiments, the LB subnet(s) 522 implemented in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may need this embodiment since database(s) that the customers use may be controlled by the IaaS provider and may be stored on the service tenancy 519. The service tenancy 519 may be isolated from public Internet 554.

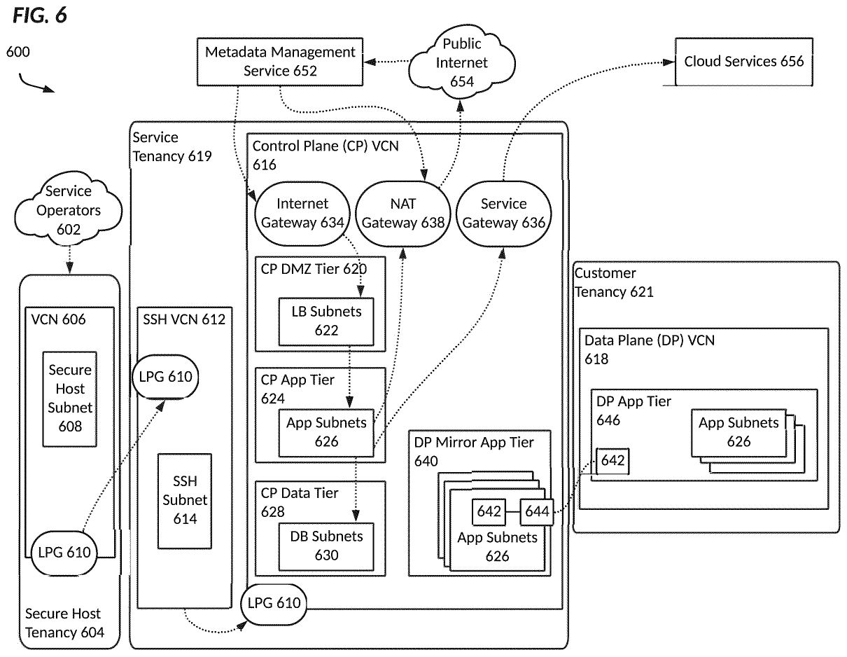

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 610 implemented in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 implemented in the control plane VCN 616. The control plane VCN 616 can be implemented in a service tenancy 619 (e.g., the service tenancy 519 of FIG. 5), and the data plane VCN 618 (e.g., the data plane VCN 518 of FIG. 5) can be implemented in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), and a control plane data tier 628 (e.g., the control plane data tier 528 of FIG. 5) that can include database (DB) subnet(s) 630 (e.g., similar to DB subnet(s) 530 of FIG. 5). The LB subnet(s) 622 implemented in the control plane DMZ tier 620 can be communicatively coupled to the app subnet(s) 626 implemented in the control plane app tier 624 and an Internet gateway 634 (e.g., the Internet gateway 534 of FIG. 5) that can be implemented in the control plane VCN 616. The app subnet(s) 626 can be communicatively coupled to the DB subnet(s) 630 implemented in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 implemented in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be implemented in a data plane app tier 646 (e.g., the data plane app tier 546 of FIG. 5). The compute instance 644 can facilitate this communication via the VNIC 642 implemented in the data plane mirror app tier 640 and the VNIC 642 implemented in the data plane app tier 646.

The Internet gateway 634 implemented in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 implemented in the control plane VCN 616. The service gateway 636 implemented in the control plane VCN 616 can be communicatively couple to cloud services 656 (e.g., cloud services 556 of FIG. 5).

In some examples, the data plane VCN 618 can be implemented in the customer tenancy 621. In this case, the IaaS provider may provide the control plane VCN 616 for a customer, and the IaaS provider may, for a customer, set up a unique, compute instance 644 that is implemented in the service tenancy 619. A compute instance 644 may allow communication between the control plane VCN 616 implemented in the service tenancy 619 and the data plane VCN 618 that is implemented in the customer tenancy 621. The compute instance 644 may allow resources provisioned in the control plane VCN 616 that is implemented in the service tenancy 619 to be deployed or otherwise used in the data plane VCN 618 that is implemented in the customer tenancy 621.

In other examples, the customer of the IaaS provider may have databases that are implemented in the customer tenancy 621. In this example, the control plane VCN 616 can include the data plane mirror app tier 640 that can include app subnet(s) 626. The data plane mirror app tier 640 can be implemented in the control plane VCN 616, but the data plane mirror app tier 640 may not be implemented in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity implemented in the control plane VCN 616. The customer may need to deploy or otherwise use resources in the data plane VCN 618 that are provisioned in the control plane VCN 616, and the data plane mirror app tier 640 can facilitate the deployment or other usage of resources of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, implemented in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be active or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 1” may be located in Region 1 and in “Region 2.” If a call to Deployment 1 is made by the service gateway 636 implemented in the control plane VCN 616 located in Region 1, the call may be transmitted to Deployment 1 in Region 1. In this example, the control plane VCN 616, or Deployment 1 in Region 1, may not be communicatively coupled to, or otherwise in communication with, Deployment 1 in Region 2.

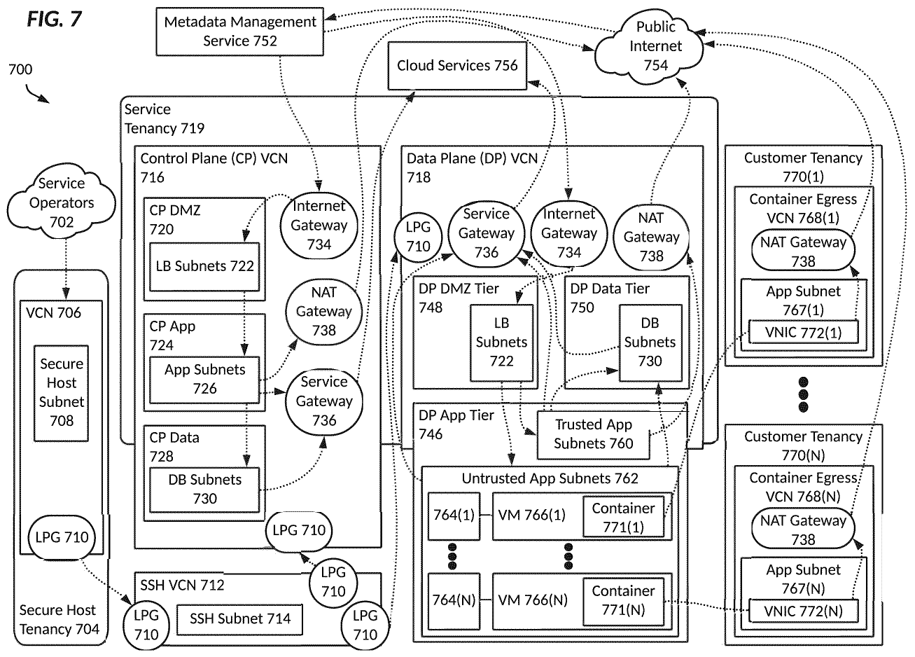

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 implemented in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 implemented in the control plane VCN 716 and to a data plane VCN 718 (e.g., the data plane VCN 518 of FIG. 5) via an LPG 710 implemented in the data plane VCN 718. The control plane VCN 716 and the data plane VCN 718 can be implemented in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), and a control plane data tier 728 (e.g., the control plane data tier 528 of FIG. 5) that can include DB subnet(s) 730. The LB subnet(s) 722 implemented in the control plane DMZ tier 720 can be communicatively coupled to the app subnet(s) 726 implemented in the control plane app tier 724 and to an Internet gateway 734 (e.g., the Internet gateway 534 of FIG. 5) that can be implemented in the control plane VCN 716, and the app subnet(s) 726 can be communicatively coupled to the DB subnet(s) 730 implemented in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760, untrusted app subnet(s) 762 of the data plane app tier 746, and the Internet gateway 734 implemented in the data plane VCN 718. The trusted app subnet(s) 760 can be communicatively coupled to the service gateway 736 implemented in the data plane VCN 718, the NAT gateway 738 implemented in the data plane VCN 718, and DB subnet(s) 730 implemented in the data plane data tier 750. The untrusted app subnet(s) 762 can be communicatively coupled to the service gateway 736 implemented in the data plane VCN 718 and DB subnet(s) 730 implemented in the data plane data tier 750. The data plane data tier 750 can include DB subnet(s) 730 that can be communicatively coupled to the service gateway 736 implemented in the data plane VCN 718.

The untrusted app subnet(s) 762 can include one or more primary VNICs 764(1)-(N) that can be communicatively coupled to tenant virtual machines (VMs) 766(1)-(N). Tenant VMs 766(1)-(N) can be communicatively coupled to a respective app subnets 767(1)-(N) that can be implemented in respective container egress VCNs 768(1)-(N) that can be implemented in respective customer tenancies 770(1)-(N). Respective secondary VNICs 772(1)-(N) can facilitate communication between the untrusted app subnet(s) 762 implemented in the data plane VCN 718 and the app subnet implemented in the container egress VCNs 768(1)-(N). Container egress VCNs 768(1)-(N) can include a NAT gateway 738 that can be communicatively coupled to public Internet 754 (e.g., public Internet 554 of FIG. 5).

The Internet gateway 734 implemented in the control plane VCN 716 and implemented in the data plane VCN 718 can be communicatively coupled to a metadata management service 752 (e.g., the metadata management service 552 of FIG. 5) that can be communicatively coupled to public Internet 754. Public Internet 754 can be communicatively coupled to the NAT gateway 738 implemented in the control plane VCN 716 and implemented in the data plane VCN 718. The service gateway 736 implemented in the control plane VCN 716 and implemented in the data plane VCN 718 can be communicatively couple to cloud services 756.

In some embodiments, the data plane VCN 718 can be integrated with customer tenancies 770(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 746. Code to execute the function may be executed in the VMs 766(1)-(N), and the code may not be configured to execute anywhere else on the data plane VCN 718. VMs 766(1)-(N) may be connected to one customer tenancy 770(1). Respective containers 771(1)-(N) implemented in the VMs 766(1)-(N) may be configured to execute the code. In this case, there can be a dual isolation (e.g., the containers 771(1)-(N) executing code), where the containers 771(1)-(N) may be implemented in at least the VM 766(1)-(N) that are implemented in the untrusted app subnet(s) 762) that may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completing execution of the code, the IaaS provider may terminate or otherwise dispose of the containers 771(1)-(N).

In some embodiments, the trusted app subnet(s) 760 may execute code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be implemented in the VM 766(1)-(N) of a customer and that may execute code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

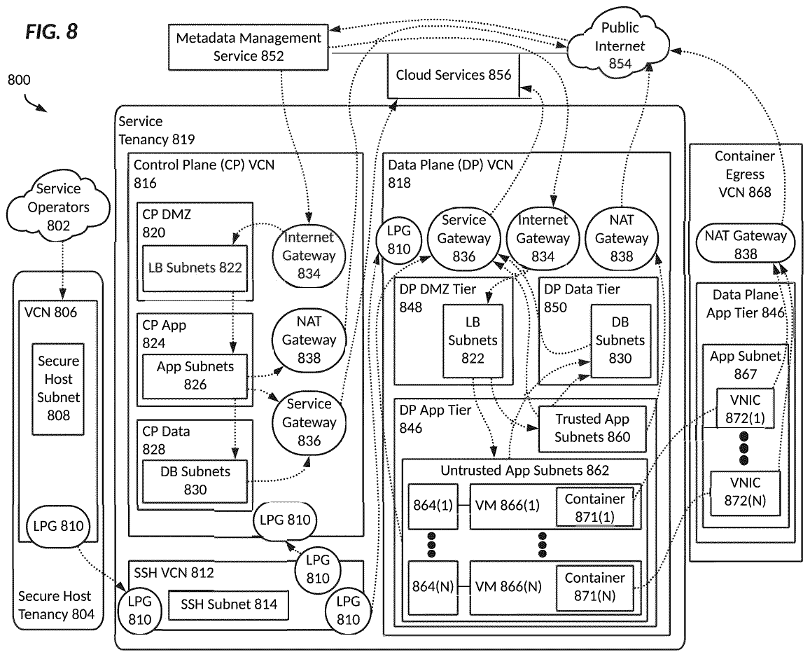

FIG. 8 is a block diagram illustrating another example pattern of an IaaS architecture 800 according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 implemented in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 implemented in the control plane VCN 816 and to a data plane VCN 818 (e.g., the data plane VCN 518 of FIG. 5) via an LPG 810 implemented in the data plane VCN 818. The control plane VCN 816 and the data plane VCN 818 can be implemented in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), and a control plane data tier 828 (e.g., the control plane data tier 528 of FIG. 5) that can include DB subnet(s) 830 (e.g., DB subnet(s) 730 of FIG. 7). The LB subnet(s) 822 implemented in the control plane DMZ tier 820 can be communicatively coupled to the app subnet(s) 826 implemented in the control plane app tier 824 and to an Internet gateway 834 (e.g., the Internet gateway 534 of FIG. 5) that can be implemented in the control plane VCN 816, and the app subnet(s) 826 can be communicatively coupled to the DB subnet(s) 830 implemented in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 implemented in the data plane VCN 818. The trusted app subnet(s) 860 can be communicatively coupled to the service gateway 836 implemented in the data plane VCN 818, the NAT gateway 838 implemented in the data plane VCN 818, and DB subnet(s) 830 implemented in the data plane data tier 850. The untrusted app subnet(s) 862 can be communicatively coupled to the service gateway 836 implemented in the data plane VCN 818 and DB subnet(s) 830 implemented in the data plane data tier 850. The data plane data tier 850 can include DB subnet(s) 830 that can be communicatively coupled to the service gateway 836 implemented in the data plane VCN 818.

The untrusted app subnet(s) 862 can include primary VNICs 864(1)-(N) that can be communicatively coupled to tenant virtual machines (VMs) 866(1)-(N) implemented within the untrusted app subnet(s) 862. Tenant VMs 866(1)-(N) can execute code in a respective container 867(1)-(N) and be communicatively coupled to an app subnet 867 that can be implemented in a data plane app tier 846 that can be implemented in a container egress VCN 868. Respective secondary VNICs 872(1)-(N) can facilitate communication between the untrusted app subnet(s) 862 implemented in the data plane VCN 818 and the app subnet 867 implemented in the container egress VCN 868. The container egress VCN 868 can include a NAT gateway 838 that can be communicatively coupled to public Internet 854 (e.g., public Internet 554 of FIG. 5).

The Internet gateway 834 implemented in the control plane VCN 816 and implemented in the data plane VCN 818 can be communicatively coupled to a metadata management service 852 (e.g., the metadata management service 552 of FIG. 5) that can be communicatively coupled to public Internet 854. Public Internet 854 can be communicatively coupled to the NAT gateway 838 implemented in the control plane VCN 816 and implemented in the data plane VCN 818. The service gateway 836 implemented in the control plane VCN 816 and implemented in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be needed for a customer of the IaaS provider if the IaaS provider cannot directly communicate with the customer (e.g., a disconnected region). The respective containers 871(1)-(N) that are implemented in the VMs 866(1)-(N) for a customer can be accessed in real-time by the customer. The containers 871(1)-(N) may be configured to make calls to respective secondary VNICs 872(1)-(N) implemented in app subnet(s) 867 of the data plane app tier 846 that can be implemented in the container egress VCN 868. The secondary VNICs 872(1)-(N) can transmit the calls to the NAT gateway 838 that may transmit the calls to public Internet 854. In this example, the containers 871(1)-(N) that can be accessed in real time by the customer can be isolated from the control plane VCN 816 and can be isolated from other entities implemented in the data plane VCN 818. The containers 871(1)-(N) may also be isolated from resources from other customers.

In other examples, the customer can use the containers 871(1)-(N) to call cloud services 856. In this example, the customer may execute code in the containers 871(1)-(N) that request a service from cloud services 856. The containers 871(1)-(N) can transmit this request to the secondary VNICs 872(1)-(N) that can transmit the request to the NAT gateway 838 that can transmit the request to public Internet 854. Public Internet 854 can transmit the request to LB subnet(s) 822 implemented in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, and 800 may include components that are different and/or additional to the components shown in the figures. Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of other clients. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for an entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Examples of Cloud Networks

As noted above, infrastructure as a service (IaaS) is one particular type of cloud computing service. In an IaaS model, customers can build their own customizable virtual or overlay networks and deploy customer resources over on-demand, scalable computing resources of CI.

The CI may comprise interconnected high-performance compute resources including various host machines, memory resources, and network resources that form a physical network, which is also referred to as a substrate network or an underlay network. The resources in CI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)) Virtual Extensible LAN (VXLAN—IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CI is physically hosted in one or more data centers in one or more regions around the world. The CI may include components in the physical or substrate network and virtualized components (e.g., virtual networks, compute instances, virtual machines, etc.) that are in a virtual network built on top of the physical network components. In certain embodiments, the CI is organized and hosted in realms, regions, and availability domains.

When a customer subscribes to an IaaS service, resources from CI are provisioned for the customer and associated with the customer's tenancy. The customer can use these provisioned resources to build private networks and deploy resources on these networks. The customer networks that are hosted in the cloud by the CI are referred to as virtual cloud networks (VCNs). A customer can set up one or more virtual cloud networks (VCNs) using CI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with publicly accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints. CI thus offers high-performance compute resources and storage capacity in flexible virtual networks that are securely accessible from various networked locations such as from a customer's on-premises network.

The CP may provide various services using the CI. In some instances, customers of CI may themselves act like service providers and provide services using CI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN, and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN, and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

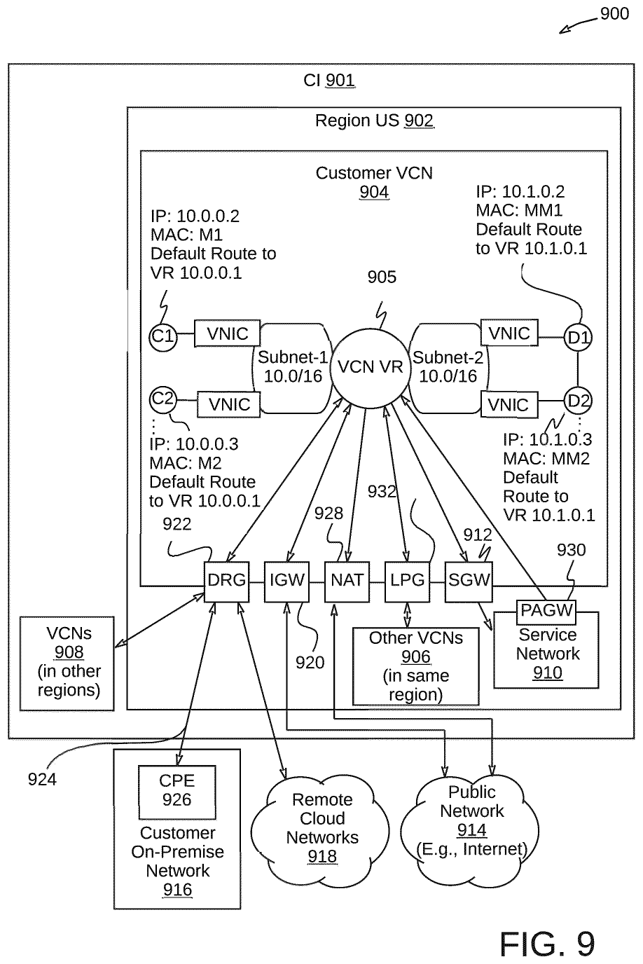

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 9. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

In certain embodiments, the creation of VCNs and subnets are handled by a VCN Control Plane (CP), and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane.

A customer may create one or more VCNs using resources hosted by CI. A compute instance deployed on a customer VCN may communicate with different endpoints. These endpoints can include endpoints that are hosted by CI and endpoints outside CI.

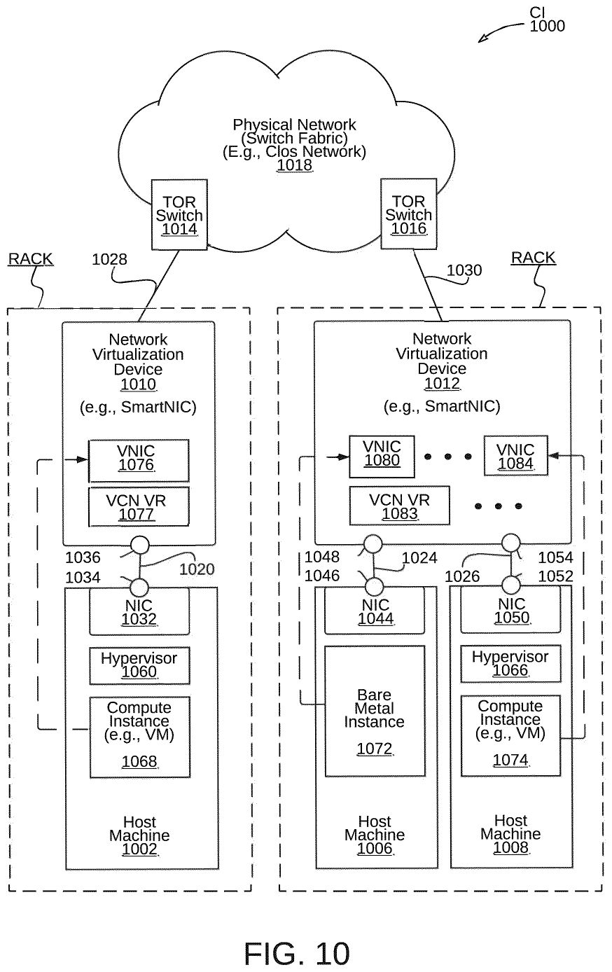

Various different architectures for implementing cloud-based service using CI are depicted in FIGS. 9-10, and are described below. FIG. 9 is a high-level diagram of a distributed environment 900 showing an overlay or customer VCN hosted by CI according to certain embodiments. The distributed environment depicted in FIG. 9 includes multiple components in the overlay network. Distributed environment 900 depicted in FIG. 9 is merely an example and is not intended to unduly limit the scope of claimed embodiments. Many variations, alternatives, and modifications are possible. For example, in some implementations, the distributed environment depicted in FIG. 9 may have more or fewer systems or components than those shown in FIG. 9, may combine two or more systems, or may have a different configuration or arrangement of systems.

As shown in the example depicted in FIG. 9, distributed environment 900 comprises CI 901 that provides services and resources that customers can subscribe to and use to build their virtual cloud networks (VCNs). In certain embodiments, CI 901 offers IaaS services to subscribing customers. The data centers within CI 901 may be organized into one or more regions. One example region “Region US” 902 is shown in FIG. 9. A customer has configured a customer VCN c/o Oracle International Corporation for region 902. The customer may deploy various compute instances on VCN 904, where the compute instances may include virtual machines or bare metal instances. Examples of instances include applications, database, load balancers, and the like.

In the embodiment depicted in FIG. 9, customer VCN 904 comprises two subnets, namely, “Subnet-1” and “Subnet-2”, each subnet with its own CIDR IP address range. In FIG. 9, the overlay IP address range for Subnet-1 is 10.0/16 and the address range for Subnet-2 is 10.1/16. A VCN Virtual Router 905 represents a logical gateway for the VCN that enables communications between subnets of the VCN 904, and with other endpoints outside the VCN. VCN VR 905 is configured to route traffic between VNICs in VCN 904 and gateways associated with VCN 904. VCN VR 905 provides a port for each subnet of VCN 904. For example, VR 905 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CI 901. A compute instance participates in a subnet via a VNIC associated with the compute instance. For example, as shown in FIG. 9, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 9, compute instance C1 has an overlay IP address of 10.0.0.2 and a MAC address of M1, while compute instance C2 has a private overlay IP address of 10.0.0.3 and a MAC address of M2. Each compute instance in Subnet-1, including compute instances C1 and C2, has a default route to VCN VR 905 using IP address 10.0.0.1, which is the IP address for a port of VCN VR 905 for Subnet-1.

Subnet-2 can have multiple compute instances deployed on it, including virtual machine instances and/or bare metal instances. For example, as shown in FIG. 9, compute instances D1 and D2 are part of Subnet-2 via VNICs associated with the respective compute instances. In the embodiment depicted in FIG. 9, compute instance D1 has an overlay IP address of 10.1.0.2 and a MAC address of MM1, while compute instance D2 has a private overlay IP address of 10.1.0.3 and a MAC address of MM2. Each compute instance in Subnet-2, including compute instances D1 and D2, has a default route to VCN VR 905 using IP address 10.1.0.1, which is the IP address for a port of VCN VR 905 for Subnet-2.

VCN A 904 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 904 can communicate with various different endpoints. These endpoints may include endpoints that are hosted by CI 1000 and endpoints outside CI 1000. Endpoints that are hosted by CI 901 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN 906 in the same region, or communications between a compute instance in Subnet-1 and an endpoint in service network 910 in the same region); or an endpoint in a VCN in a different region (e.g., communications between a compute instance in Subnet-1 and an endpoint in a VCN 908 in a different region). A compute instance in a subnet hosted by CI 901 may also communicate with endpoints that are not hosted by CI 901 (i.e., are outside CI 901). These outside endpoints include endpoints in the customer's on-premises network 916, endpoints within other remote cloud hosted networks 918, public endpoints accessible via a public network 914 such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 9 wants to send a packet to compute instance D1 in Subnet-2, the packet is first processed by the VNIC associated with compute instance C1. The VNIC associated with compute instance C1 is configured to route the packet to the VCN VR 905 using default route or port 10.0.0.1 of the VCN VR. VCN VR 905 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 904 to an endpoint that is outside VCN 904, the communication is facilitated by the VNIC associated with the source compute instance, VCN VR 905, and gateways associated with VCN 904. One or more types of gateways may be associated with VCN 904. A gateway is an interface between a VCN and another endpoint, where another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 904. The packet may be first processed by the VNIC associated with source compute instance C1. The VNIC processing determines that the destination for the packet is outside the Subnet-1 of C1. The VNIC associated with C1 may forward the packet to VCN VR 905 for VCN 904. VCN VR 905 then processes the packet and as part of the processing, based upon the destination for the packet, determines a particular gateway associated with VCN 904 as the next hop for the packet. VCN VR 905 may then forward the packet to the particular identified gateway. For example, if the destination is an endpoint within the customer's on-premise network, then the packet may be forwarded by VCN VR 905 to Dynamic Routing Gateway (DRG) gateway 922 configured for VCN 904. The packet may then be forwarded from the gateway to a next hop to facilitate communication of the packet to it final intended destination.

Various different types of gateways may be configured for a VCN. Examples of gateways that may be configured for a VCN are depicted in FIG. 9 and described below. As shown in the embodiment depicted in FIG. 9, a Dynamic Routing Gateway (DRG) 922 may be added to or be associated with customer VCN 904 and provides a path for private network traffic communication between customer VCN 904 and another endpoint, where another endpoint can be the customer's on-premise network 916, a VCN 908 in a different region of CI 901, or other remote cloud networks 918 not hosted by CI 901. Customer on-premise network 916 may be a customer network or a customer data center built using the customer's resources. Access to customer on-premise network 916 is generally very restricted. For a customer that has both a customer on-premise network 916 and one or more VCNs 904 deployed or hosted in the cloud by CI 901, the customer may want their on-premise network 916 and their cloud based VCN 904 to be able to communicate with each other. This enables a customer to build an extended hybrid environment encompassing the customer's VCN 904 hosted by CI 901 and their on-premises network 916. DRG 922 enables this communication. To enable such communications, a communication channel 924 is set up where one endpoint of the channel is in customer on-premise network 916 and the other endpoint is in CI 901 and connected to customer VCN 904. Communication channel 924 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 916 that forms one end point for communication channel 924 is referred to as the customer premise equipment (CPE), such as CPE 926 depicted in FIG. 9. On the CI 901 side, the endpoint may be a host machine executing DRG 922.

In certain embodiments, a Remote Peering Connection (RPC) can be added to a DRG, which allows a customer to peer one VCN with another VCN in a different region. Using such an RPC, customer VCN 904 can use DRG 922 to connect with a VCN 908 in another region. DRG 922 may also be used to communicate with other remote cloud networks 918, not hosted by CI 901 such as a Microsoft Azure cloud, Amazon AWS cloud, and others.

As shown in FIG. 9, an Internet Gateway (IGW) 920 may be configured for customer VCN 904 the enables a compute instance on VCN 904 to communicate with public endpoints accessible over a public network 914 such as the Internet. IGW 920 is a gateway that connects a VCN to a public network such as the Internet. IGW 920 enables a public subnet (where the resources in the public subnet have public overlay IP addresses) within a VCN, such as VCN 904, direct access to public endpoints on a public network 914 such as the Internet. Using IGW 920, connections can be initiated from a subnet within VCN 904 or from the Internet.

A Network Address Translation (NAT) gateway 928 can be configured for customer's VCN 904 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 904, with private access to public endpoints on the Internet. In NAT gateways, connections can be initiated only from the private subnet to the public Internet and not from the Internet to the private subnet.

In certain embodiments, a Service Gateway (SGW) 912 can be configured for customer VCN 904 and provides a path for private network traffic between VCN 904 and supported services endpoints in a service network 910. In certain embodiments, service network 910 may be provided by the CP and may provide various services. An example of such a service network is Oracle's Services Network, which provides various services that can be used by customers. For example, a compute instance (e.g., a database system) in a private subnet of customer VCN 904 can back up data to a service endpoint (e.g., Object Storage) without needing public IP addresses or access to the Internet. In certain embodiments, a VCN can have only one SGW, and connections can only be initiated from a subnet within the VCN and not from service network 910. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 126 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 932 is a gateway that can be added to customer VCN 904 and enables VCN 904 to peer with another VCN in the same region. Peering means that the VCNs communicate using private IP addresses, without the traffic traversing a public network such as the Internet or without routing the traffic through the customer's on-premises network 916. In preferred embodiments, a VCN has a separate LPG for each peering it establishes. Local Peering or VCN Peering is a common practice used to establish network connectivity between different applications or infrastructure management functions.

Service providers, such as providers of services in service network 910, may provide access to services using different access models. According to a public access model, services may be exposed as public endpoints that are publicly accessible by compute instance in a customer VCN via a public network such as the Internet and or may be privately accessible via SGW 126. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 930 is a gateway resource that can be attached to a service provider VCN (e.g., a VCN in service network 910) that acts as an ingress/egress point for all traffic from/to customer subnet private endpoints. PAGW 930 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 930 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 932 and the PE in the customer's VCN.

A customer can control routing in a VCN at the subnet level, so the customer can specify which subnets in the customer's VCN, such as VCN 904, use each gateway. A VCN's route tables are used to decide if traffic is allowed out of a VCN through a particular gateway. For example, in a particular instance, a route table for a public subnet within customer VCN 904 may send non-local traffic through IGW 920. The route table for a private subnet within the same customer VCN 904 may send traffic destined for CP services through SGW 126. All remaining traffic may be sent via the NAT gateway 928. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked, and the response is automatically allowed without an explicit security list rule for the response traffic) or stateless.

Access from a customer VCN (i.e., by a resource or compute instance deployed on VCN 904) can be categorized as public access, private access, or dedicated access. Public access refers to an access model where a public IP address or a NAT is used to access a public endpoint. Private access enables customer workloads in VCN 904 with private IP addresses (e.g., resources in a private subnet) to access services without traversing a public network such as the Internet. In certain embodiments, CI 901 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CI may offer dedicated public access using technologies such as FastConnect public peering where customer on-premises instances can access one or more services in a customer VCN using a FastConnect connection and without traversing a public network such as the Internet. CI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CI and its services. FastConnect provides an easy, elastic, and economical way to create a dedicated and private connection with higher bandwidth options and a more reliable and consistent networking experience when compared to Internet-based connections.

FIG. 9 and the accompanying description above describes various virtualized components in an example virtual network. As described above, the virtual network is built on the underlying physical or substrate network. FIG. 10 depicts a simplified architectural diagram of the physical components in the physical network within CI 1000 that provide the underlay for the virtual network according to certain embodiments. As shown, CI 1000 provides a distributed environment comprising components and resources (e.g., compute, memory, and networking resources) provided by a cloud service provider (CP). These components and resources are used to provide cloud services (e.g., IaaS services) to subscribing customers, i.e., customers that have subscribed to one or more services provided by the CP. Based upon the services subscribed to by a customer, a subset of resources (e.g., compute, memory, and networking resources) of CI 1000 are provisioned for the customer. Customers can then build their own cloud-based (i.e., CI-hosted) customizable and private virtual networks using physical compute, memory, and networking resources provided by CI 1000. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CI 1000 provides infrastructure and a set of complementary cloud services that enable customers to build and run a wide range of applications and services in a highly available hosted environment.

In the example embodiment depicted in FIG. 10, the physical components of CI 1000 include one or more physical host machines or physical servers (e.g., 1002, 1006, 1008), network virtualization devices (NVDs) (e.g., 1010, 1012), top-of-rack (TOR) switches (e.g., 1014, 1016), and a physical network (e.g., 1018), and switches in physical network 1018. The physical host machines or servers may host and execute various compute instances that participate in one or more subnets of a VCN. The compute instances may include virtual machine instances, and bare metal instances. For example, the various compute instances depicted in FIG. 9 may be hosted by the physical host machines depicted in FIG. 10. The virtual machine compute instances in a VCN may be executed by one host machine or by multiple different host machines. The physical host machines may also host virtual host machines, container-based hosts or functions, and the like. The VNICs and VCN VR depicted in FIG. 9 may be executed by the NVDs depicted in FIG. 10. The gateways depicted in FIG. 9 may be executed by the host machines and/or by the NVDs depicted in FIG. 10.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 10, host machines 1002 and 1008 execute hypervisors 1060 and 1066, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 10, hypervisor 1060 may sit on top of the OS of host machine 1002 and enables the computing resources (e.g., processing, memory, and networking resources) of host machine 1002 to be shared between compute instances (e.g., virtual machines) executed by host machine 1002. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 10 may have the same or different types of hypervisors.

A compute instance can be a virtual machine instance or a bare metal instance. In FIG. 10, compute instances 1068 on host machine 1002 and compute instances 1074 on host machine 1008 are examples of virtual machine instances. Host machine 1006 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 10, host machine 1002 executes a virtual machine compute instance 1068 that is associated with VNIC 1076, and VNIC 1076 is executed by NVD 1010 connected to host machine 1002. As another example, bare metal instance 1072 hosted by host machine 1006 is associated with VNIC 1080 that is executed by NVD 1012 connected to host machine 1006. As yet another example, VNIC 1084 is associated with compute instance 1074 executed by host machine 1008, and VNIC 1084 is executed by NVD 1012 connected to host machine 1008.

For compute instances hosted by a host machine, an NVD connected to that host machine also executes VCN VRs corresponding to VCNs of which the compute instances are members. For example, in the embodiment depicted in FIG. 10, NVD 1010 executes VCN VR 1077 corresponding to the VCN of which compute instance 1068 is a member. NVD 1012 may also execute one or more VCN VRs 1083 corresponding to VCNs corresponding to the compute instances hosted by host machines 1006 and 1008.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 10, host machine 1002 is connected to NVD 1010 using link 1020 that extends between a port 1034 provided by a NIC 1032 of host machine 1002 and between a port 1036 of NVD 1010. Host machine 1006 is connected to NVD 1012 using link 1024 that extends between a port 1046 provided by a NIC 1044 of host machine 1006 and between a port 1048 of NVD 1012. Host machine 1008 is connected to NVD 1012 using link 1026 that extends between a port 1052 provided by a NIC 1050 of host machine 1008 and between a port 1054 of NVD 1012.

The NVDs are in turn connected via communication links to top-of-the-rack (TOR) switches, which are connected to physical network 1018 (also referred to as the switch fabric). In certain embodiments, the links between a host machine and an NVD, and between an NVD and a TOR switch are Ethernet links. For example, in FIG. 10, NVDs 1010 and 1012 are connected to TOR switches 1014 and 1016, respectively, using links 1028 and 1030. In certain embodiments, the links 1020, 1024, 1026, 1028, and 1030 are Ethernet links. The collection of host machines and NVDs that are connected to a TOR is sometimes referred to as a rack.

Physical network 1018 provides a communication fabric that enables TOR switches to communicate with each other. A communication fabric, also called network fabric or fabric, refers to a physical network structure that includes a set of interconnected switches that provide multiple redundant pathways for data flow between a set of computing devices. A fabric enables high-throughput, low-latency communication through structured, multi-path routing. A fabric has a topology that defines a physical layout and arrangement of the set of interconnected switches and links. The physical layout and arrangement of the set of interconnected switches and links define pathways for data to flow across the fabric. In an embodiment, physical network 1018 can be a multi-tiered network. In certain implementations, physical network 1018 is a multi-tiered Clos network of switches, with TOR switches 1014 and 1016 representing the leaf level nodes of the multi-tiered and multi-node physical switching network 1018. Example network fabrics employing different network topologies, such as a Clos topology, are further described below in Section 9, titled “Example Network Fabrics.”

### 9. Example Network Fabrics

Computing components located in the various racks of a data center are interconnected to one another by fabric. The term “network fabric” or “fabric” generally refers to a physical network structure that includes a set of interconnected switches that provide multiple redundant pathways for data flow between a set of computing devices. A fabric enables high-throughput, low-latency communication through structured, multi-path routing.

A fabric is associated with a topology that defines a physical layout and arrangement of the set of interconnected switches and links. The physical layout and arrangement of the set of interconnected switches and links define pathways for data to flow across the fabric. An example network topology is multi-tiered Clos topology. A multi-tiered Clos topology is a type of non-blocking, multistage or multi-tiered switching network topology, where the number of stages or tiers can be two, three, four, five, etc. A Clos network with “n” stages may be referred to as a “n”-tiered network. Each switch in “tier n” is connected to each switch in “tier n+1.” In a 2-tier spine, t1 may be referred to a leaf layer, and t2 may be referred to as a spine layer. The spine layer can server as a high-speed backbone, interacting with the leaf layer.

A fabric can include different groups of switches and clients, referred to as “fabric groups” and “client groups,” arranged in various variations or arrangements of network topologies. Each tier of the fabric includes one or more fabric groups. The leaf tier includes one or more client groups (e.g., computing servers, GPU servers, and/or end devices). A “role” of a fabric group is associated with the tier of the fabric group. For example, a role of a fabric group in t1 may be “leaf”; and a role of a fabric group in t2 may be “spine.”

Each fabric group has a defined number of switches. Each switch has one or more south-facing ports, also called “downlinks,” and one or more north-facing ports, also called “uplinks.” The south-facing ports of switches in a fabric group of an upper tier may be connected to the north-facing ports of switches in a fabric group of a lower tier.

The configuration of connections between switches of fabric groups of adjacent tiers may be referred to as “linking configurations” or “linking rules.” Examples of linking configurations include a full mesh configuration, or a partial mesh configuration. In a full mesh configuration, every south-facing port of switches of an upper fabric group is directly connected to every north-facing port of switches of a lower fabric group. The non-blocking configuration allows connections to be made between switches in adjacent tiers without interference from currently established connections. Various cablings options may be used to implement the links, such as Active Optical Connectors (AOCs); high-speed optical transceivers that uses Coarse Wavelength Division Multiplexing (CWDM); and/or high-speed, hot-pluggable, low-power-dissipation optical transceivers.

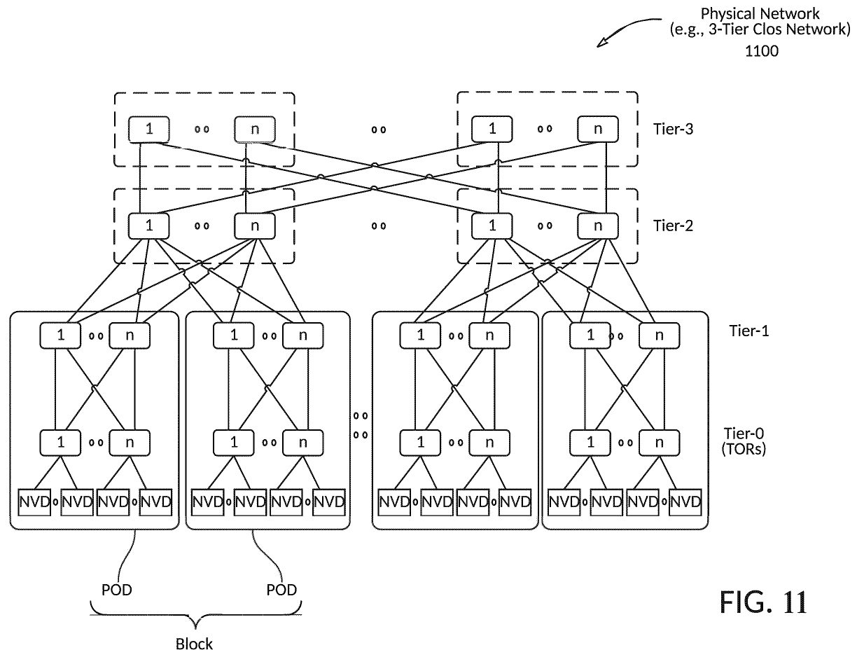

FIG. 11 depicts a simplified block diagram of a physical network 1100 structured as a Clos network according to certain embodiments. The embodiment depicted in FIG. 11 is a 3-tiered network comprising tiers 1, 2, and 3. The TOR switches represent Tier-0 switches in the Clos network. One or more NVDs are connected to the TOR switches. Tier-0 switches are also referred to as edge devices of the physical network. The Tier-0 switches are connected to Tier-1 switches (also referred to as leaf switches). In the embodiment depicted in FIG. 11, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 1100 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In an embodiment, a single site implements multiple networks, each implemented by one or more network fabrics. Each network in a site may serve a different purpose, such as a front-end network, a back-end network, a management network, and/or other networks. Each network fabric in a site may be implemented using a different network topology or a different combination of network topologies.

As examples, a compute network fabric architecture (CNFA) is configured to connect with non-network racks (compute, storage, service enclave, etc.) within a datacenter. CNFA may be implemented as a 3-tier Clos network. A junction network fabric architecture (JNFA) is configured to connect with network device roles, including: CNFAs; internet gateways; dedicated private connections to on-premise datacenters of customers; and backbone devices. JNFA may be implemented as a 2-tier Clos network. A management network fabric architecture (MNFA) is configured to connect with management devices. In an example, a site includes a CNFA, JNDA, and MNFA. The CNFA may include multiple (e.g., six) blocks. For external connectivity, a subset of t2 blocks (e.g., one t2 block) of the CNFA in a site is dedicated to connecting to t1 switches of the JNFA (rather than t3 super-spine switches of the CNFA, as described above). Further, one or more t1 switches of the JNFA are dedicated to connecting to t1 switches of the MNFA.

As further examples, performance network fabric architectures (PNFA) may be used. PNFA provides connectivity for cluster networks, such as high-performance computer (HPC) networks, high-performance database platform networks, and GPU networks. PNFA enables fine-grained traffic engineering that supports Quality of Service (QoS), which is a set of technologies that manage network traffic to prioritize critical applications. PNFA supports RDMA over Converged Ethernet (e.g., RoCE vi and/or ROCEv2), Virtual eXtensible Local-Area Network (VXLAN), dynamic load balancing (DLB), Dot1x, etc. Different variants of PNFA have different numbers of tiers, e.g., two, three. In an example, a site may include a CNFA and a PNFA. “RDMA” or “Remote Direct Memory Access” generally refers to a technology that allows computing devices to access each other's memory directly without using the operating system.

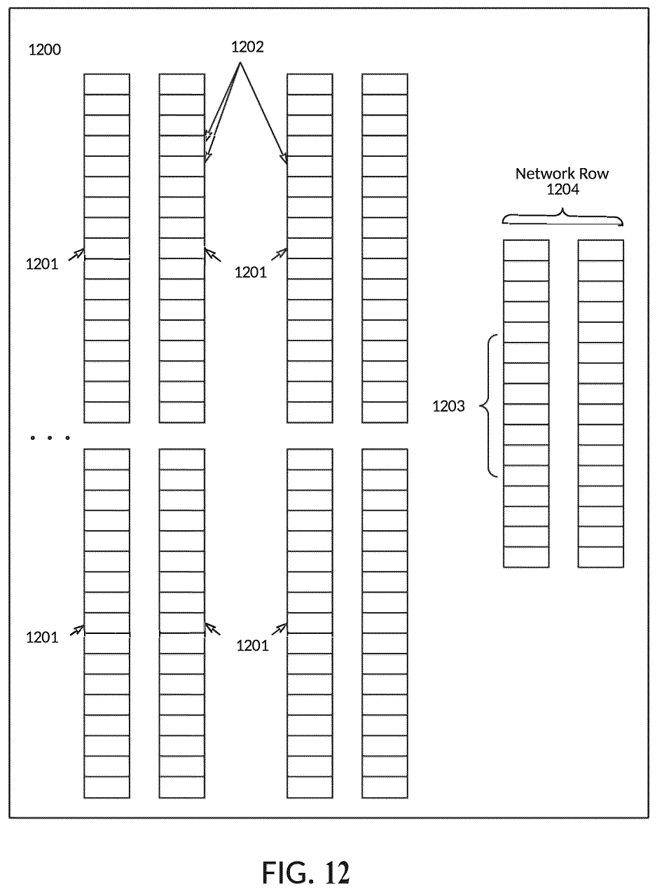

A fabric topology is implemented by physical racks of switches. In an embodiment, each block of switches in a network fabric is implemented in separate racks within a datacenter. FIG. 12 depicts a data hall 1200 containing rows of compute racks and network racks, with the network racks implementing a network fabric, according to certain embodiments. The leaf block racks 1201 may be located on the data hall floor adjacent to host-containing racks 1202, effectively providing the data hall with functionality of an intermediate distribution frame (IDF). The spine block racks 1203 may be located in a network row 1204 in the data hall 1200, effectively providing the data hall with functionality of a main distribution frame (MDF). Several data halls can be combined to provide a data center with a larger capacity.

### 10. Hardware System

According to one embodiment, the techniques described herein are implemented by one or more special-purpose computing devices. The special-purpose computing devices may be hard-wired to perform the techniques or may include digital electronic devices, such as one or more application-specific integrated circuits (ASICs), field programmable gate arrays (FPGAs), or network processing units (NPUs) that are persistently programmed to perform the techniques. Also, the special-purpose computing devices may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices, or any other device that incorporates hard-wired and/or program logic to implement the techniques.

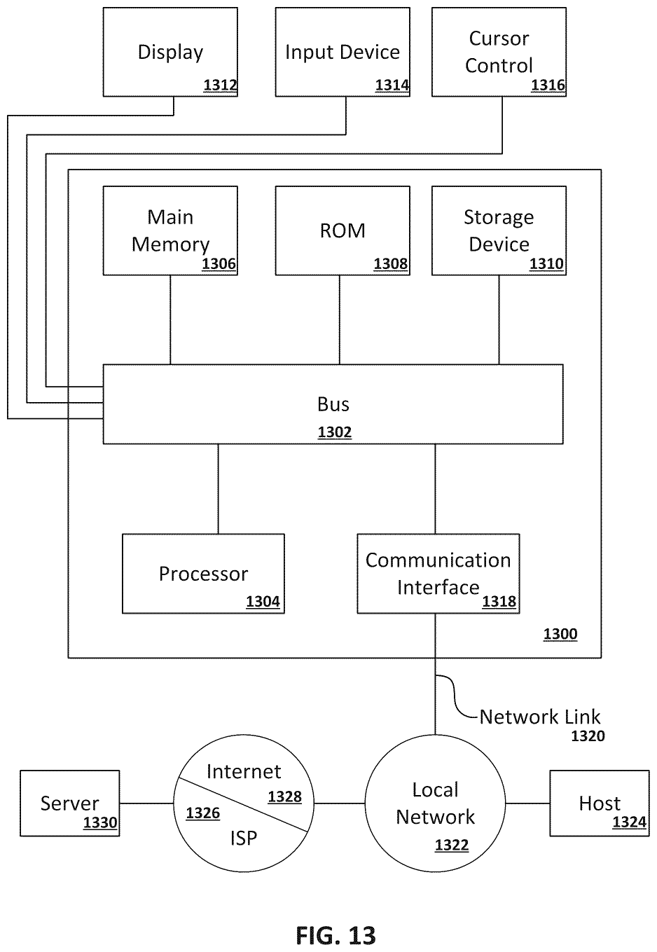

For example, FIG. 13 is a block diagram that illustrates a computer system 1300 upon which an embodiment of the disclosure may be implemented. Computer system 1300 includes a bus 1302 or other communication mechanism for communicating information, and a hardware processor 1304 coupled with bus 1302 for processing information. Hardware processor 1304 may be, for example, a general-purpose microprocessor.

Computer system 1300 also includes a main memory 1306, such as a random-access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 1310, such as a magnetic disk, optical disk, or a Solid-State Drive (SSD) is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware, and/or program logic that in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1310. Volatile media includes dynamic memory, such as main memory 1306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid-state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic, or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the worldwide packet data communication network now commonly referred to as the “Internet” 1328. Local network 1322 and Internet 1328 both use electrical, electromagnetic, or optical signals that carry digital data streams. The signals through the various networks and the signals on network link 1320 and through communication interface 1318, that carry the digital data to and from computer system 1300, are example forms of transmission media.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

### 11. Miscellaneous; Extensions

Embodiments are directed to a system with one or more devices that include a hardware processor and that are configured to perform any of the operations described herein and/or recited in any of the claims below. Embodiments are directed to a system that includes means to perform any of the operations described herein and/or recited in any of the claims below. In an embodiment, a non-transitory, computer-readable storage medium comprises instructions that, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. Accordingly, the specification and drawings are to be regarded in an illustrative rather than a restrictive sense. The sole and exclusive indicator of the scope of patent protection, and what is intended by the applicants to be the scope of patent protection, is the literal and equivalent scope of the set of claims that issue from this application in the specific form that such claims issue, including any subsequent correction.

References, including publications, patent applications, and patents, cited herein are hereby incorporated by reference to the same extent as if the references were individually and specifically indicated to be incorporated by reference and were set forth in entirety herein.

What is claimed is:

1. A method, comprising:
instantiating a fabric model entity comprising a data structure representing a model of a data center fabric, the fabric model entity comprising (a) a first group entity representing at least a first set of device model entities corresponding to a first portion of the model and (b) a second group entity representing at least a second set of device model entities corresponding to a second portion of the model;
selecting at least one linking rule that defines one or more criteria for linking the first set of device model entities of the first group entity to the second set of device model entities of the second group entity;
based on the at least one linking rule, instantiating, in the model, at least one linking entity that defines a set of links between the first set of device model entities of the first group entity and the second set of device model entities of the second group entity,
wherein the set of links defined by the at least one linking entity comprises, for each device model entity of the first set of device model entities, at least one link with at least one device model entity, of the second set of device model entities;
wherein the method is performed by at least one device including a hardware processor.

2. The method of claim 1, wherein each device model entity, of the second set of device model entities, is linked with at least one device model entity, of the first set of device model entities, by at least one link of the set of links.

3. The method of claim 1, wherein the second group entity represents a third set of device model entities corresponding to the second portion of the model, wherein the third set of device model entities are not linked to the first set of device model entities of the first group entity.

4. The method of claim 3,
wherein the fabric model entity comprises a third group entity representing additional device model entities corresponding to a third portion of the model,
wherein a first linking entity, of the at least one linking entity defines a first set of links between the first set of device model entities of the first group entity and the second set of device model entities of the second group entity, and
wherein a second linking entity, of the at least one linking entity defines a second set of links between the third set of device model entities of the second group entity and the additional device model entities of the third group entity.

5. The method of claim 4, wherein the second linking entity does not define links between the second set of device model entities and the additional device model entities of the third group entity.

6. The method of claim 1,
wherein selecting the at least one linking rule comprises:
selecting a logical linking rule that indicates whether particular first device model entities and particular second device model entities are to be linked to one another;
wherein instantiating the at least one linking entity comprises:
based on the logical linking rule, instantiating a logical linking entity that defines a set of logical links between the first set of device model entities of the first group entity and the second set of device model entities of the second group entity.

7. The method of claim 6, wherein the logical linking rule comprises at least one of:
a first parameter indicating whether particular first device model entities, of the first set of device model entities, are linked to particular second device model entities, of the second set of device model entities; or
a second parameter indicating whether particular first ports of particular first device model entities, of the first set of device model entities, are linked to particular second ports of particular second device model entities, of the second set of device model entities.

8. The method of claim 6, wherein the logical linking rule comprises a linking arrangement corresponding to at least one tier of a fabric topology.

9. The method of claim 8, wherein the linking arrangement comprises at least one of:
a first arrangement indicating that every device model entity of the first set of device model entities is linked to every device model entity of the second set of device model entities;
a second arrangement indicating that every device model entity of the first set of device model entities is linked to multiple device model entities of the second set of device model entities;
a third arrangement indicating that multiple device model entities of the first set of device model entities are linked to a particular device model entity of the second set of device model entities; or
a fourth arrangement indicating that every device model entity of the first set of device model entities has n-number of links to every device model entity of the second set of device model entities.

10. The method of claim 1,
wherein selecting the at least one linking rule comprises:
selecting a physical linking rule that indicates how particular first device model entities and particular second device model entities are to be linked to one another;
wherein instantiating the one or more linking entities comprises:
based on the physical linking rule, instantiating a physical linking entity that defines a set of physical links between the first set of device model entities of the first group entity and the second set of device model entities of the second group entity.

11. The method of claim 10, wherein the physical linking rule comprises at least one of:
a first parameter indicating a type of cabling utilized for a set of connections between the first set of device model entities and the second set of device model entities; or
a second parameter indicating whether the first set of device model entities are linked to the second set of device model entities via direct connections; or
a third parameter indicating whether the first set of device model entities are linked to the second set of device model entities via structured cabling.

12. The method of claim 10,
wherein the physical linking rule comprises a parameter indicating a type of transceiver for connections between the first set of device model entities and the second set of device model entities.

13. The method of claim 10,
wherein the physical linking rule comprises at least one of:
a first parameter indicating a first type of connector for connecting cabling to the first set of device model entities; or
a second parameter indicating a second type of connector for connecting cabling to the second set of device model entities.

14. The method of claim 10,
wherein the physical linking rule indicates whether passive infrastructure is utilized for connections between the first set of device model entities and the second set of device model entities.

15. The method of claim 1, further comprising:
selecting the at least one linking rule based on at least one of: (a) a first parameter of a first device model entity, of the first set of device model entities, or (b) a second parameter of a second device model entity, of the set of one or more second device model entities.

16. The method of claim 1, further comprising:
selecting the at least one linking rule based at least in part on one or more of:
(i) a first role of a first device model entity, of the first set of device model entities, or
(ii) a second role of a second device model entity, of the second set of device model entities.

17. The method of claim 1, further comprising:
selecting the at least one linking rule based at least in part on one or more of:
(i) a first linking mode for linking to a first device model entity, of the first set of device model entities, or
(ii) a second linking mode for linking to a second device model entity, of the second set of device model entities.

18. The method of claim 1, wherein selecting the at least one linking rule comprises:
selecting a logical linking rule that indicates whether particular first device model entities, of the first set of device model entities, and particular second device model entities, of the second set of device model entities, are to be linked to one another;
based on the logical linking rule, selecting a physical linking rule that indicates how particular first device model entities, of the first set of device model entities, and particular second device model entities, of the second set of device model entities, are to be linked to one another.

19. The method of claim 1, wherein instantiating the one or more linking entities comprises:
instantiating a logical linking entity that defines a set of logical links between the first set of device model entities of the first group entity and the second set of device model entities of the second group entity,
based on the logical linking entity, instantiating a physical linking entity that defines a set of physical links between the first set of device model entities of the first group entity and the second set of device model entities of the second group entity.

20. The method of claim 1,
wherein the first group entity comprises a leaf group;
wherein the second group entity comprises a spine group.

21. The method of claim 1,
wherein the first group entity comprises a fabric group entity;
wherein the second group entity comprises a client group entity.

22. The method of claim 1, further comprising:
selecting a fabric model template from a catalog;
instantiating the fabric model entity based on the fabric model template;
wherein the fabric model template comprises a first group template corresponding to the first group entity and a second group template corresponding to the second group entity.

23. One or more non-transitory computer readable media storing instructions that, when executed by one or more hardware processors, cause performance of a set of operations comprising:
instantiating a fabric model entity comprising a data structure representing a model of a data center fabric, the fabric model entity comprising (a) a first group entity representing at least a first set of device model entities corresponding to a first portion of the model and (b) a second group entity representing at least a second set of device model entities corresponding to a second portion of the model;
selecting at least one linking rule that defines one or more criteria for linking the first set of device model entities of the first group entity to the second set of device model entities of the second group entity;
based on the at least one linking rule, instantiating, in the model, at least one linking entity that defines a set of links between the first set of device model entities of the first group entity and the second set of device model entities of the second group entity,
wherein the set of links defined by the at least one linking entity comprises, for each device model entity of the first set of device model entities, at least one link with at least one device model entity, of the second set of device model entities.

24. A system comprising:
one or more hardware processors;
one or more non-transitory computer-readable media; and
program instructions stored on the one or more non-transitory computer-readable media that, when executed by the one or more hardware processors, cause the system to perform operations comprising:
instantiating a fabric model entity comprising a data structure representing a model of a data center fabric, the fabric model entity comprising (a) a first group entity representing at least a first set of device model entities corresponding to a first portion of the model and (b) a second group entity representing at least a second set of device model entities corresponding to a second portion of the model;
selecting at least one linking rule that defines one or more criteria for linking the first set of device model entities of the first group entity to the second set of device model entities of the second group entity;
based on the at least one linking rule, instantiating, in the model, at least one linking entity that defines a set of links between the first set of device model entities of the first group entity and the second set of device model entities of the second group entity,
wherein the set of links defined by the at least one linking entity comprises, for each device model entity of the first set of device model entities, at least one link with at least one device model entity, of the second set of device model entities.
